(19) United States
(12) Patent Application Publication
(10) Pub. No.: US 2026/0246355 A1
(43) Pub. Date: Aug. 20, 2026

(54) SUPERCONDUCTING MOTORS AND COMPONENTS THEREOF

(71) Applicant: ELECTRIC MAYHEM, LLC, Littleton, CO (US)

(72) Inventor: Glenn Auld KNIERIM, Littleton, CO (US)

(73) Assignee: ELECTRIC MAYHEM, LLC, Littleton, CO (US)

(21) Appl. No.: 19/404,757

(22) Filed: Dec. 1, 2025

Related U.S. Application Data
(63) Continuation-in-part of application No. 18/349,135, filed on Jul. 8, 2023, now Pat. No. 12,603,563.
Application No. 18/349,135 is a continuation-in-part of application No. PCT/US22/13662, filed on Jan. 25, 2022.
Application No. PCT/US22/13662 is a continuation-in-part of application No. 17/159,047, filed on Jan. 26, 2021, now Pat. No. 11,878,892.

(51) Int. Cl. H02K 55/04; H02K 1/16; H02K 1/278; H02K 11/01; H02K 21/46

(52) U.S. Cl. CPC H02K 55/04; H02K 1/16; H02K 1/278; H02K 11/014; H02K 21/46; H02K 2201/03

(57) ABSTRACT

An improved system for handling delicate linear media and in particular to a method and apparatus for winding delicate linear media such as superconducting wire or tape or optical fibers onto a spool or former, and electric machines produced thereby. A combination of direct closed loop control and media routing design facilitates the handling of the delicate media without causing damage. The axial tension in the linear media may be closely controlled during winding by means of feedback control loop using tension measurements to control the rotation speeds of the wind-from and wind-to spools. Further, during winding, the delicate linear media is only exposed to large radius bends with no reverse bending. Finally, output devices and features, commercial or otherwise, made possible by delicate linear media handling are revealed. This includes advanced SC devices and features.

This application is a Continuation-in-Part of U.S. patent application Ser. No. 18/349,135, Jul. 8, 2023, which is a Continuation-in-Part of PCT Application Serial No. PCT/US22/13622, published as WO2017053611, filed Jan. 25, 2022, which claims the benefit of U.S. patent application Ser. No. 17/159,047, filed Jan. 26, 2021, now U.S. Pat. No. 11,878,892, issued on Jan. 23, 2024.

### FIELD OF THE INVENTION

Embodiments of the present invention are generally related to products and devices made from winding superconductors into magnets, cables, and/or cable magnets.

### BACKGROUND OF THE INVENTION

Superconductors (sometimes referred to herein as “SC”) have the promise of bringing pure efficiency (i.e., 100% efficiency), which would allow for the manufacture of innovative devices that can accommodate increased energy and power requirements in a compact package and through HTS use provide for lessened cryogenic requirements via LN2 use. Current commercially-available advanced SC products, such as magnets, cables, and cable magnets, are virtually non-existent because superconductors, including those that can tolerate higher temperatures, are fragile. Accordingly, the winding process must consider the fragile SC media during handling, winding, and final operation.

HTS machines are desired across industries from individual device to enabling electric system solutions. Conventional copper (Cu) and permanent magnet (PM) machines are limited by air gap magnetic flux density (B), torque, thermal, and power output. Cu cooling needs are also great and add to system weight. Conventional machines use iron (Fe) to increase their air gap B but at the expense of weight. An HTS direct drive machine has no thermal loss and over 6× a conventional machine torque limit due to the B output. The air gap is the non-magnetic space between the primary and secondary of any electromagnetic device.

After decades no HTS or MTS device, including electric machines (particularly motors & generator), have moved beyond laboratory-based demonstration levels. Due to winding limitations, other HTS winding machine attempts focus on making a pancake stack machine field coil with only limited protection from HTS winding and operational stress. Pancake stacks increase harmonic content, move the coils further from the air gap, which lowers the air gap B, and thus cannot be used for complex winds such as armature coils. Further, pancake stacks are not curved to protect the HTS tape from quenching due to high B locations. There have been no attempts to create a fully HTS via a fully cold, cryogenically cooled on both the armature and rotor, machine due to the difficulty in winding HTS armature coils, which leads to a machine that gains less than half of SC operational benefits. Other MTS solutions have lower material cost but when reacted are even more fragile and have a higher cryostat cost and complexity given a lower operating temperature and potentially more dangerous cryogen.

Those of ordinary skill in the art will appreciate that manufacturing for HTS applications requires complex geometric materials to experience low winding stress which allows increased operating values. This requirement is exacerbated when manufacturing complex geometric magnets categorized by their primary mounting and rotation needs, which include solenoid (often mounted on a common central turning platform), planar (such as a racetrack coil or a curved plane cos-theta magnet and often mounted on cylindrical tooling), and spherical (such as a baseball or yin-yang magnets). Advances in HTS operational values, their performance, the reliability of cryogenic systems, connections, etc., and the understanding that HTS material costs drop during production have collectively targeted SC manufacturing as the remaining issue for commercial SC applications.

### SUMMARY OF THE INVENTION

One embodiment of the present invention is an electric motor, e.g., and electric device, generally comprised of a stator, which remains stationary and includes either coils of conductive windings or permanent magnets configured to generate a magnetic field when energized, and a rotor, positioned within the stator, that is rotatably mounted to convert magnetic interaction into mechanical motion. Windings of the stator and/or rotor may consist of high temperature superconducting (HTS) and/or medium temperature superconducting (MTS), a conventional conductor, such as copper, or a combination thereof. In addition, permanent magnets of the stator/rotor may consist of magnets or cable magnets comprised at least partially of SC materials as described in U.S. patent application Ser. No. 18/349,135 and other references mentioned herein.

Air core devices. Those of ordinary skill in the art will appreciate that electric devices often employ an iron core, which produces high magnetic flux (B). Hybrid cores are also used but are not a good solution due to high B, which is far above iron (Fe) lamination saturation levels of ~0.6 to 1.1T for costly laminations and associated losses. Further, Fe is heavy and brittle at cryogenic temperatures. Accordingly, it is another aspect of some embodiments of the present invention to provide a device that employs an air core instead of an iron core to address high B. Accordingly, such electric devices are lighter than traditional iron core devices, eliminate iron hysteresis loss, reduce circulating current losses, increase allowable primary and secondary coil winding areas, provide a flexible structure for large and complex well installation, use the complete B path or magnetic energy, and possess lower total harmonic distortion emanating from an associated electrical circuit. An air core design with no Fe B continuity needs means all magnets can be wound at once or into connectable sections when forming the final device.

Winding Sections. In a hybrid to air core design, particularly for superconductors, the necessity of using continuous iron to direct the magnetic flux density is removed which allows winding to assembly sections. Embodiments include any electrical winding such as electric machines, transformers, fault current limiters, NMR/MRI, and SMES. In the electric machine embodiment both the stator and rotor can then be built to wind, 3D print or otherwise created and assemble in winding sections to connect when forming the final device. These sections are created externally from the final device for winding and/or ease of assembly including providing line replaceable units and/or a means of activating TFMs outside of the final machine.

Multiple Wind Magnets. Winding multiple, separate magnets at once provides the ability to wind multiple magnets with no splice between magnets. Embodiments include multiple magnets such as multiple electric machine primary and/or secondary windings such as for the same phase. Other embodiments include concentric rings for the embodiments of a transformer or fault current limiter or SMES. Other embodiments include multiple cylindrical coils for use in high energy physics particle accelerators or NMR/MRI.

3D Printing of Superconducting Winding to Application Parts. It is one aspect to provide 3D print parts specific to superconducting, particularly HTS and MTS application. That is, 3D print parts could be used in electric machines, MRIs, and NMRs, regular to high-frequency transformers, fault current limiters, SMES, common to specialty magnetic device cores, winding formers and tooling, etc. Due to the extremely high superconductor current and magnetic field capable needs and benefits, use of 3D printing for final applications and products can be of extreme benefit, such as assisting the development and operation of fully cryogenically cold and power-dense devices, rotary electric machines with high structural capability at high-speeds, thermal conductive paths, specialty materials such as Titanium (Ti) for SC use, and lower mass devices and systems. A linear, rotary, arc and all other electric machine embodiments include elements to complete electric machine rotor and stator to hold the field and armature windings including winding support to final operational formers, including hybrid to fully air core formers, as well as other magnetic elements such as trapped field magnet (TFM) and permanent magnets, as well as non-magnetic elements. Any magnet, cable, and/or cable magnet device includes 3D printing for magnetic paths, cryostats and cryogenic cooling and conductive paths, gas paths (e.g., cryogenic liquid to gas expansion paths), electromagnetic (EM) shields and shield mounts, supporting and controlling EM and mechanical effects such as via mechanical and/or electrical high-speed and frequency induced EM effects, conductive cooling and quench support, structural support, allows increased manufacturability of components to systems, means of minimizing part counts and cost, increasing reliability, etc.

3D printing a core improves manufacturability, reduces part count, reduces system size and weight, increases power density, allows for winding groups and high-speed force, allows for fully cold cryo-to-conductive cooling, and decreases cost. Due to compact sizing, titanium parts of one embodiment provides a lightweight and strong AC machine. Further, for such an electric machine, a 3D printed sectional rotor and stator provides an evacuated air gap that removes windage and icing concerns. It is also contemplated that TFMs can be secured into 3D printed machined pockets. To achieve a strong magnet structure and remove voids for the complex 3D tape angle and placement, a vacuum impregnated epoxy design may be used for production magnets. 3D printed dove tails to hold field coils, for example, can be implemented for high rotor speeds, which also provides lowered stray loss from a smaller air gap. A core structure, such as air core, with cooling channels and set thermal links can be added to the structure.

All electric machine or similar inventions described herein apply to a rotary, linear, arc, etc. type of motional AC or DC device. In a rotary or arc electric machine the stator is the stationary part and the rotor is the moving part. A rotor is commonly the radially inside, but either can be on the radially inside or outside. Portions of this disclosure refer to “primary” and “secondary” portions of electric machines. The “primary” is the location of the armature, which is commonly the stationary part of the electric machine, i.e., the component of an electric machine that carries AC current in an AC machine. The “secondary” is the active or passive moving component that responds to the primary of the electric machine. In an AC machine the secondary comprises magnetic field producing elements (magnetic coils, permanent magnets, trap field magnets, etc. or some combination) used in an AC synchronous machine and passive conductors used in an AC induction machine, which will be described in more detail below.

Superconducting Electric Machine of any Flux Type. It is yet another aspect of some embodiments of the present invention to provide radial, axial, transverse, and any other flux type device that employs HTS, wherein the motor's stator and/or rotor portions are cryogenically cooled. The transverse flux motor components can also be partial or half cold. In one contemplated AC induction machine a field coil side can be replaced with conductive material, such as short circuited, passive HTS tapes perhaps in the form of coils, a squirrel cage, or sheet equivalent.

One embodiment of the contemplated invention is an air core AC or DC superconducting machine with HTS EM armature coils and HTS EM and trapped field magnet (TFM) field poles, which maximizes rotational speed, removes all possible losses, provides the most efficient, power-dense, and specific power machine possible with today's technology. A fully HTS electric machine including complex curve multi-turn per layer HTS field and armature coils increases efficiency and power for the very low mass and volume, especially for a smaller sized machine electric machine, beyond any other currently possible within the same rotor velocity range.

Fully Cold HTS Device. It is one aspect of some embodiments of the present invention to provide a fully-cold electric device. As used herein, “fully cold” refers to both primary (e.g., stator for an electric machine) and secondary (e.g., rotor for an electric machine, being at LN₂ temperatures. The temperature of the components can be maintained at SC temperatures by bathing the device in cryogen, providing cryogen channels or reservoirs integrated into the components, providing a cryogen reservoir in thermal communication with the components (see, PCT/US23/68945, which is incorporated in its entirety herein), etc. The contemplated fully cold device can be an electric machine (e.g., motor/generator) having superconductors (SC) incorporated into all components of the device, such as both the primary and secondary of an electromagnetic device such as an electric machine. One of ordinary skill in the art will appreciate that it is also possible to provide an electric machine with fully cold or cryogenic features but with a combination of SCs and conventional conductors. Alternatively, corresponding components can operate at different temperature regimes, wherein one component operates at conventional cryogenic temperatures, and the other component operates at fully or partially SC temperatures.

Fully cold HTS electric machine with curved HTS coil transformational benefits include: 1) highest efficiency (>99.0%); 2) highest power and power density; 3) lightest weight; 4) smallest size; 5) highest torque; 6) highest air gap B; 7) no internal heat generation; 8) no resistive losses (particularly beneficial for short axial length machines such as most circumferential machines); 9) safely wound HTS commercial production magnets; 10) first ever complex curve multi-turn per layer HTS field and armature coils; 11) fully cold machine; 12) TFMs incorporated with EM coils into the field poles; 13) TFM activation inside of the machine due to combined field and armature EM coil activation method; 14) least amount of conductor tape/wire required; and 15) manufacturing ease from winding to modular stackable/swappable subassemblies for all frame sizes. In this example, HTS primary losses are 85% removed. Machine performance increase is related to the number of magnets converted to HTS, starting with the removal of all magnet resistive losses.

Tape Curvature and Alignment for B Path. Complex wind and curve the linear media for the best B path operation which is especially important for HTS tapes. Iron, which controls the B path (including a normal B into the air gap), is absent in an air core device. Accordingly, a curved winding pattern is used to accommodate B path needs. Properly designed complex 3D shaped SC magnets allow compact and lighter sizing for high efficiency and B without exceeding HTS critical values. Multi-layer magnets, such as an electric machine field coil, incorporates radii at their corners to curve the B path and minimize placement of HTS in the highest B regions, like electric machine Fe tooth curves for limiting motor saturation. The highest HTS induced current occurs when the external B is perpendicular to the tape width, so in another unique design step, each HTS tape is placed and oriented to set the HTS width parallel to the highest B. When this configuration is impossible, such as certain armature configurations, HTS EM shields deflect the highest B from the tape width.

Flat Fan Magnetic Coil. The winding ability described herein turns the considered negatives of HTS tape geometry to an advantage. Flat Fan compact coil embodiments range from common EM-based devices to any EM specialty devices, such as radial, linear, arc, and circumferential electric machines (examples include a motor for an aircraft turbofan and a generator for a wind turbine), transformers, fault current limiters, superconducting energy storage rings (SMES), NMR/MRI, electromagnetic pulse generators (EMP), cable magnets, thrust tubes such as for exo-atmospheric satellite ion propulsion, fusion reactors, and high energy physics particle accelerator beam compression/recompression and focusing to deflection magnets. For an electric machine embodiment, this increases electric machine performance far beyond any other machine attempt with an electrical machine as close to an ideal sinewave machine as current technology allows for a discrete, multi-turned winding. In an electric machine, any stator or rotor coils [both primary (armature) and secondary (field, passive secondary, etc.) coil sides] can assume the flat fan configuration and certain field pole configurations can include TFMs and the stator or rotor can be on the inside radius and either can include the armature or field coils.

An extremely high power, compact device of any type is also possible because HTS has no internal heat generation at any non-critical current level, excluding minute solder joint and EM transient conductor heating. No heat generation means there are no current thermal limits, no EM shielded winding cooling beyond cryo cool down, no parallel winds needed for internal current heating, etc. Given no large heat generation concerns, specialized complex HTS winding placement turns the very thin nature of HTS to an advantage, allowing a new “Flat Fan” coil to be built and placed into a new configuration. The flat fan coil uses a thin tape profile such as an HTS (often 0.1 mm with 1 micrometer for HTS) by placing the HTS tape width (often 2 to 12 mm) facing width along the straight length, like a shallow saddle coil that is densely packed and curved. B acts in a direction across the surface current, which is highest parallel to the longest length, so orienting the tape width perpendicular or close to perpendicular to the air gap gives the highest B across the air gap. Long wind depths are no longer required versus a single (pancake), double, or, as expected, at most only a few layers winding, also allowed with max. B into the airgap due to flux exclusion as the B travels from the furthest (e.g., outer) layer tapes to the airgap with the thin HTS maintaining their path. When compacted into a pancake coil that curves to the air gap, this configuration places the thickness of all armature and secondary coil turns at the surface next to the air gap with no layers moving the HTS away from the air gap but with 100's to 1000's of turns with all at high currents. This configuration maximizes the air gap B while minimizing losses. When superimposing the B for many parallel, discrete turns aligned together, an extremely high B is attained. The limit is then defined by the maximum B for each HTS tape group region where discrete B loops are separated across the circumference versus the superposition of many turns into a deep tooth for the embodiment of a common radial machine.

A Flat Fan HTS magnet design allows the removal to minimization of slots and harmonic losses with a small air gap and support for magnetic and mechanical forces, main issues with slotless winds. The HTS provided high air gap B allows an air core machine which, along with no PM use, removes all hysteretic losses. An evacuated or non-air air gap removes all windage loss. Cryogenic cooling loss is equivalent to conventional cooling loss. A slotless armature allows a high rpm, removal of slot losses, construction ease, and good armature back plane cooling, including removing the need to separate coil turns and coil groups for cooling purposes. The armature phases and field coils can then be placed next to one another, with or without a phase-to-phase HTS shielding layer, and then structurally bind all HTS phases into single armature and/or field coil rings. Without slots and only shallow surface coils, the diameter, the best machine dimension to decrease for sizing and weight reduction needs, is minimized with only structural support and cooling beyond the radially outermost coils.

Secondary coils such as field coils follow a similar structure of winding to thermal support as the armature. If operations including a quench do not structurally or thermally allow a slotless wind, then short, thin teeth or equivalent can also be incorporated. Harmonics are minimized in this highly distributed armature and secondary wind with each turn (of possibly 100's of turns for a small sized electric rotary, linear, arc, etc. machine and only increasing for larger sized machines) next to the air gap providing a slight B electromotive force (emf) step versus slot generated emf from concentrated windings with most turns far from the air gap. A coil is then a compact series of either vertical or angled HTS turns. In the individual HTS angle case each turn can be wound to partially overlap one another to further remove harmonics, further decrease any unwanted induced B in the tape width while providing the highest air gap B, and this V-pattern assists with creating coil end turns by always rotating the HTS thickness side into the turn. For this case the HTS of the armature and/or secondary coil halves are angled into an overlapping V-pattern with respect to the B path. The contemplated angle may be slight due to the aspect ratio common to HTS—long length and relatively thin width.

The armature phase half turns in one embodiment turn inwards with respect to the secondary to accommodate the secondary B moving past the armature. To provide the highest induced B in the secondary, the secondary turns are expected to turn inwards with respect to the secondary pole to accommodate any B moving past the pole. The addition of a skew angle is also possible. A fractional pitch wind can further remove any harmonics remaining. Without harmonics, mostly due to the highly distributed wind, all non-leakage B goes into the power producing fundamental frequency and thus greatly approximates a pure sinusoidal machine.

If the stray B is minimized, critical HTS current is not approached, and if the B across the tape width is acceptable, then any tape width desired can be used for either the armature or field coils embodiment. For a high current machine, larger HTS widths provide a higher current output with a faster response time. On the lower end, smaller HTS widths allow many ampere-turns for a multi-layer coil or a high power, highly compact HTS single layer machine. Electrically, more turns give a higher emf with a natural current filter where HTS is already a high current output. More layers provide a higher power density within B and current critical limits.

Flat Fan End Turns. Conventional device end turns often experience leakage flux and Cu loss due to no back-iron and geometries that move the end turns away from the air gap and not orthogonal to the secondary. To use end turns as part of the magnetic length, orient end turns in an electric machine where poles can overlap end turns on one or both sides making them part of the magnetic length due to: 1) the flat, fan geometry of the HTS end turns; 2) the short end turns air gap; 3) 45-degree or smaller end turn angle with respect to the straight armature length; and 4) no end turn resistive losses. Mainly for an air core and compact and/or short axial machine where the end turns are a large axial length percentage, this adds power density and efficiency by increasing useable axial length and removing leakage inductance for the end turns and nearby straight magnetic length. If the phase power is not smooth due to no phase transition region such as chording, phase overlaps, enough inductive lag, end turn magnet lengths smooth phase power by automatically overlapping.

Curved Flat Fan Coils and TFMs. In one electric machine embodiment, the field coils are common coils or flat fan with multi-dimensional curved sides to control the B path and further accommodate trapped field magnets (TFM), such as but not limited to HTS TFMs, to further increase the air gap B and output performance. The TFMs can be activated into different pole orientations, which is of great benefit for changing the output from the same electric machine without having to rebuild the electric machine such as changing out the secondary. In a further electric machine embodiment of an HTS electric machine, the EM coil outsides curve to enclose all TFMs while maximizing the B for a small air gap pole area that overlaps multiple armature phases. The HTS EM field pole: 1) activates the TFMs in the machine; 2) maximizes the field B; 3) augments and controls the B for a higher and more efficient fundamental B for each rpm; and 4) waveform shapes power generation when in a self-excitation mode with the armature. Because the TFM B forms the shape of an equilateral triangle with the maximum at the puck middle surface, in one embodiment TFMs are placed side to side facing and angled with the air gap to provide the maximum average air gap B. The entire pole is then curved to decrease the curved air gap to allow the highest B without quench while providing a variable air gap length at each pole end to further lower harmonics. Field coil TFMs are epoxied into place, which protects the TFM and for ease of rotor manufacturing. Sensors and heaters placed with the TFMs control deactivation. Rotor poles are connected to form a cylinder for structural support.

An electric device of one embodiment of the present invention employs un-activated SC TFMs oriented such that a desired activation B (magnetic flux density) can be achieved. In operation, opposing SC flat fan coils and/or EM field coils located about or near the SC TFMs establish a high B into the SC TFMs to achieve a set SC TFM B. This procedure is performed before and/or during cryogenic cool down of TFMs. The device is ready to use once the SC TFMs are activated.

TFM activation in a conventional or half HTS EM wound machine is a large concern due to the limitations of Cu winds and the maximum B they can hold across the TFM as well as Fe limitations. This concern is removed for a superconducting, such as HTS and MTS, EM due to the high B with no heat generation and further with hybrid to air core benefits. In one embodiment, TFM activation is achieved by aligning the field pole to a specific armature phase location and applying a same direction DC B across both the armature and field HTS coils.

AC losses are a known concern, particularly for the outer coil turns because all inner turns are magnetic flux density (B) HTS shielded. The slotless to minimal slot flat fan employed by some of the electric machines described herein greatly reduces AC losses for multiple reasons. In addition, slotless to minimal slot fans lower the non-useable inductance area. Further, HTS has large AC magnetization losses due to the high aspect ratio when the B is perpendicular to the HTS width. The common method of electrically isolated filaments to lower AC losses is not possible with HTS. Flat fan best approximates such electrically isolated filaments and lowers AC losses by N number of tapes for 1 width. A slotless to minimal slot wind also has no outer turns loss and meets the desire to locate B as normal as possible across the air gap. As B enters the flat fan HTS width, only a tangential B across the HTS width remains due to flux exclusion leading to lower AC losses and a normal air gap B. For wider tapes and/or more layers, flat fan provides a higher power and lower AC loss ratio. Finally, allowing B across each HTS tape width increases B penetration compared to a radial layered wind, also lowering AC losses.

EM Shields. In an electric machine embodiment, electromagnetic (EM) shields of an SC such as HTS or conventional conductor and the option to cryogen cool, both options allowing a high conductivity which greatly increases the EM shielding, are employed over the field poles, between armature phases, and over non-magnetic length end turns. These unique EM shield windings, with HTS being one embodiment: 1) lower quench issues; 2) support a higher B in a tight and contained path, especially in smaller magnets; 3) lowers mass by removing Fe and HTS turn needs; 4) optimize efficiency by minimizing stray and hysteretic B loss while allowing more current per HTS strand. For an embodiment of an armature magnetic length and end turn EM shielding, one to multiple single strips of parallel HTS with possibly soldered ends is used. In the armature length, the HTS strips and/or amortisseur bars are placed between the phases. End turns will use shorted HTS strip EM shields between phases to protect against high frequency losses such as power conditioning system (PCS) switching, a larger concern when resistance is removed. In some embodiments, a field pole EM shield for armature transients is required to minimize transient EM losses. In such cases if a field cryostat is required, then the stainless steel or aluminum or titanium or equivalent conductive metal cryostat wall will be considered for the EM shield, or shorted HTS strips are placed over the field poles. Due to the high conductivities and skin depth of all metals at cryogenic temperature, any high frequency metal EM shield is very thin. Cryogenic cooling paths for all EM shields can provide an excellent inductively generated heat removal mechanism.

Induction SC Electric Machine. Use wound secondary SC coils and/or squirrel cage configuration to obtain a high induced B and/or use HTS, such as many turns stacked or similarly in parallel, to provide an induced current path for starting torques and/or oscillation damping. An SC machine does not have the inherent resistive damping of a conventional machine which can lead to rotor oscillations. Embodiments to remove damping include embedding Cu or aluminum (Al) amortisseur bars, variable external resistors, and/or the power electronics drive where any listed device can include cryogen cooling to increase performance. These solutions also help control the speed/torque characteristics of an induction machine. For example, wound secondary motors with equivalent poles as the armature can be started with the highest torque and a low inrush current by inserting high resistance into the rotor circuit. As the motor accelerates, the secondary resistance can be decreased, coils shorted at maximum speed, to maintain maximum power. In all operational modes the benefits of an SC are achieved due to the extremely high induced emf. An embodiment is an HTS flat flan wound secondary with LN2 cooled damping bars between the winds and a potential skew opposite the armature coil or in place of an armature skew achieves a high performance output.

Combined Induction and Synchronous SC Electric Machine. A fully HTS electric machine with no resistance losses, high currents, and a high number of turns in a small packing factor has the benefit of combining the two AC machine types, induction and synchronous. Operate the same electrical machine as an induction, secondary is an induced passive B, or synchronous, secondary is active B, machine. This allows an extreme coupled B for both inductance and synchronous machine modes and hence high power and efficiency across all speeds. This HTS machine embodiment has a higher HTS cost and machine to power conditioning system (PCS) control complexity, but the benefits from this first ever machine can be critical for certain applications from industrial to electric vehicles (EV). An HTS wound induction solution provides a high self-starting torque to torque frequency range and efficiency due to the high induced currents with no loss. High starting torques and higher efficiency and power across speed ranges allow better total lifetime cost (TLC) for high torque motion and start/stop EVs (off-road construction, buses, aircraft ascent, and tugboats). An HTS synchronous solution allows extreme efficiency and power at optimal speeds where the secondary B is varied to maximize torque at the desired speed. Optionally, TFMs can be incorporated and activated for synchronous mode to greatly increase the power and/or close circuit the secondary in a passive mode with respect to external circuitry else do not activate the TFMs for inductive mode operation.

Electric vehicles, which include aircraft operating with DC or AC, employ low voltage systems for safety. Due to cooling issues at low air pressures and humidities, conventional conductors experience higher-than-expected losses at high currents. Low voltage systems also experience dielectric degradation and power-derated operation. The contained environment of a cryogen system removes both the high voltage (V) and current (I) AC issues. For ground vehicles, higher torque across the speed range, including down to starting torque, requires more current and less voltage, which is optimal for a superconducting motor. Comparatively, an AC is a high velocity, low torque system, especially once in flight.

Small motors have limited room for poles which affects their capabilities such as: 1) lowered speed from a lower number of poles for the entire electric machine; 2) lowered torque due to the amount of current carrying conductors that fit into a pole area; 3) lowered efficiency due to the minimized room for cooling and ability to aim the B towards the air gap. The induction and synchronous SC motor/generator of one embodiment employs high current and a power factor (pf) provided by a flat fan provides a high B and torque density even in a small motor with a small pole area from a high number of poles. This provides a smaller, lighter electric machine with a high power across the torque speed curve, which increases AC reliability by allowing distributed electric propulsion (DEP) with many times motor redundancy. If a quench, etc. occurs derating the current, then high amounts of HTS stabilizer not only quench protects the HTS but if electrically insulated then the contemplated SC motor/generator can still operate derated for AC if the system enters a higher voltage and lowered current mode. A higher number of poles assists with this high voltage operation. Such an operation also provides a more reliable AC system.

Combined Induction and Synchronous SC Electric Machine Mode and Operation Damping. Secondary coils are shorted for an induction machine response and coils are active with or without TFMs or permanent magnets (PM) for a synchronous machine response. Precise control is required to achieve the optimal torque-velocity when moving between induction (for variable speeds and/or slower speeds with higher torques) and synchronous (for optimized constant speeds) modes. An induction machine mirrors the armature poles, so in one embodiment a wound induction secondary can go into a common induction machine mode with external resistances or field weakening down to shorted coils or move into a synchronous mode by DC powering different pole configurations as set via connections for different pole numbers. The synchronous poles of choice are DC powered to lock from an inductive slip into a synchronous mode with limited hunting oscillations. An SC machine does not have the inherent resistive damping of a conventional machine which can lead to rotor oscillations. In another embodiment the external resistors including conductive cryo cooling are an extra rotor damping option but are not expected to be required due to the extreme air gap B stiffness and damping versus typically far lower motor output power pull leaving only high frequency, low power oscillations that the HTS and HTS coating should accommodate. Another embodiment includes variable pole options for how rotor based persistent switches close as passive inductive or active field coils. In one embodiment, a simplified mechanical rotary coupling is provided that receives cryo cooled HTS parallel stacked for a +/−DC bus down the middle with LN2 in/out flow lines, DC bus in cryo, and then slip ring sensor and control lines for field coil persistent switches on/off control outside of the cryo and power rotor center. All coils share the same DC power.

Compact Advanced Superconducting Devices. It is another aspect of some embodiments of the present invention to provide advanced, compact devices made of superconductors. The superconductors may be made or processed using the techniques described herein. Contemplated compact SC devices include but are not limited to: motor and generator machines, magnetic resonance imagining (MRI), nuclear magnetic resonance (NMR), surface NMR (SNMR) (which includes surface MRI (SMRI)), fault current limiters (FCL), and any device that includes or uses a high EM field and/or current partly to fully created by an advanced SC. Advanced SCs contain materials that allow superconducting operation at higher temperatures and are generally more to significantly more mechanically fragile. The disclosed devices can be used for motors and generators, medical applications, geoscience applications, wind energy generators, hydro-electric generators, hybrid or all-electric vehicles, oil and gas applications, magnetic containment, high energy physics (HEP) and fusion applications, including high B magnets, greater than 16 Tesla (T) magnets, power systems, aeronautical and aerospace applications, EM propulsion (magprop), EM levitation (maglev), space EM shielding, ship systems, ground transportation, military, utility, agricultural, construction, mining, environmental, resource management, disaster relief, archeology, and any industry using an EM system. Although some of the instant disclosure is focused on compact systems, those of skill in the art will appreciate SC devices of any size can be manufactured.

Compact Superconducting Device. The compact advanced SC of one embodiment is a high output and/or resolution device compact in size and weight. Some compact SC devices may be personnel portable employing power, energy storage, controls, data acquisition (DAQ), operator interface, and cryogenic systems.

Component Based Superconducting Device. Another embodiment of the invention includes the SC magnet set and other elements being swappable components or line replaceable units (LRUs).

Hybrid Superconducting Magnetics and Control. As mentioned above, the magnetics of one embodiment employ conventional electromagnet (EM) conductors and/or permanent magnets and complete wound SC and/or bulk TFM type SC. In one embodiment, the SC is surrounded by Cu or the hybrid material is comprised of SC embedded wound Cu, parallel magnets, and/or cable magnets. For cable magnets, conductor in conduit type of technology is an option for the wind. Embodiments include using magnetics of one type of source, such controlled and wound SC, to control and shape the magnetics of another type of source, such as a TFM or permanent magnet, whether part of the same magnet or pole or not.

SC Hybrid Device Operation. An electric device such as any magnet-based device, e.g., an electric machine, employing a hybrid of SC and conventional conductors has increased reliability because it is capable of several operation modes. One embodiment of the present invention is capable of at least three modes: a full power mode, a derated mode, and a baseline mode. The peak performance is achieved during full power mode (Mode 0), wherein cryogen cools both the HTS and the conventional conductor of at least one of the primary, e.g., stator, and secondary, e.g., rotor. Accordingly, full power mode has inherent fault current limiting aspects, protecting against HTS quench, i.e., loss of superconducting performance, which may briefly occur locally but is not fatal to peak performance. A derated mode (Mode 1) occurs when the HTS has quenched or is not functioning at a peak level, but the conventional conductor and/or partial HTS are still functional. In the derated mode the cryo-cooled conventional conductor can handle more current than when the system is in the baseline mode (Mode 2), where the conventional conductor functions at ambient temperature. That is, LN₂ loss will still support operational minimums. Thus, if the HTS quenches, the large amount of Cu surrounding the HTS will run the motor with LN₂, wherein the Cu will have 8× improved conductivity at 77K than 300K, allowing the motor to function long enough for emergency landing or base return. Some embodiments also comprise a resistive fault current limiting (FCL) and optional inductive FCL or FCL cable that limits current spikes such as for each mode change that can damage the device.

Superconducting Tape Coating Insulation. The superconducting tape used in some applications is electrically insulated with a thermoplastic resin coating (e.g., Formvar), HAPT (a coating comprising a modified polyester basecoat and a polyamide topcoat), or equivalents thereof. The contemplated coating provides complete insulation and protection for the superconductor with no voltage tracking length. Such coatings are not used for high temperature superconductors such as rare-earth barium copper oxide (ReBCO), commonly wrapped with Kapton® tape, which can be prone to movement and gapping, adversely affecting insulative performance.

Combined Superconducting Magnetics and Speed. Some embodiments of the invention allow for the combination of increased speed of a partial to complete SC device, which increases energy density and specific energy while not losing efficiency due to speed induced transient losses. In an electric machine embodiment, maximizing B with a fully HTS device and high (5,000 rpm and above) to extreme speeds (10,000 rpm and above) supports highest power and size savings, leading to an ultra-high power and compact size through improved specific power/energy and power/energy density.

Exciter/Transformer for Rotary Devices. Rotary exciters and/or transformers, which those of skill in the art will mean the same electromagnetic interaction, are found in conventional electric machines. A rotary exciter is a generator mechanically coupled to the shaft of a larger motor or generator and configured to supply direct current to the electric machine's field windings. In operation, the exciter's stator produces alternating or direct current as its rotor turns with the main shaft; if alternating current is produced, it is rectified-often by a rotating rectifier assembly mounted on the same shaft-before being delivered to the field windings. This arrangement eliminates the need for high-current slip rings or brushes, increases reliability, and allows precise control of excitation, making it common in large synchronous machines such as high-power AC motors as described herein. A rotary transformer is an electromechanical device for transferring alternating current power or signals between stationary and rotating components without direct electrical contact. It comprises a primary winding on a stationary core and a secondary winding on a rotating core, the two being magnetically coupled across a small air gap. Power or data is transmitted via electromagnetic induction, enabling operation at high rotational speeds with minimal electrical noise and no brush or slip-ring wear, thus offering high reliability and reduced maintenance in applications such as precision instrumentation, medical imaging equipment, and radar systems.

One embodiment of the present invention is an electronic device that produces high magnetic flux wherein the exciter is cryogenically cooled and incorporates superconducting and/or conventional components. Some embodiments of the present invention provide an electrical connection transformer for a superconducting electric machine, wherein the electrical contacts are removed from the cryogenic rotary coupling and replaced with rotary exciters/transformers that power superconducting or cryogenically cooled conventional field coils. In some cases, superconducting or cryogenically cooled conventional armature coils are employed. In all cases a higher coil turn ratio is achieved by decreasing conductor size (i.e., by reducing HTS width), where resistance is negligible, which allows for a lower current solution.

Cryogenic connections associated with electric motors, and any other SC device, such as SC cables, transformers, fault current limiters, etc., often a transformer type of power transfer for electrical terminations to remove extreme heat loading of thermal conductivity to the outside world. Superconductors on the cryogen side of a cryostat allow very efficient transfer with no to limited inductive heating on the SC side. The connector setup of one embodiment of the present invention, comprises a single-to-multiple phased system with the SC coils oriented at cryostat end circles at different axes, in line with the cryostat on the same axis, or as a toroidal cryostat end. A possible inline phased configuration is to position the SC on the inside of the axis and the cryostat has a recess for the conventional conductor, allowing conventional magnets to align with the same diameter as the SC. Superconducting Magnetic Prime Mover Power System Approach. The magnetic prime mover power system focus is atypical for an SC machine. Large scale efficiency and performance increase for any electrical machine is commonly achieved through the energy system means of increased relative motion of the magnetic reference frame, for example, the armature and exciter field coil in a synchronous motor and/or generator machine, and/or by maximizing the magnetic air gap magnetic flux density (B) for a particular operational temperature (T). This energy system approach is the future of SC machines once SC materials allow further increases. This common approach is not the direct focus of this embodiment. Instead, this embodiment incorporates a power system approach from the benefits of increased current density (J) from a system mindset.

Magprop. The winding to application descriptions herein, such as all electric machine descriptions, as applied to electromagnetic propulsion (magprop) including the embodiment of an HTS and MTS applied to any and all SC linear or curved electric machines of any type for terrestrial to extraterrestrial use including magnetic levitation (maglev) train propulsion and vehicle launchers including space launch systems.

Superconducting Inertial Propulsion. The winding to application descriptions herein, such as all electric machine descriptions, as applied to electromagnetic inertial propulsion including the embodiment of an HTS and MTS applied to any and all SC inertial propulsion of any type for terrestrial to extraterrestrial, including space, use including ion propulsion systems.

Maglev. The winding to application descriptions herein, such as all electric machine descriptions, as applied to magnetic levitation (maglev) including the embodiment of an HTS and MTS applied to any and all SC linear curved electric machines of any type for terrestrial to extraterrestrial use including magnetic levitation (maglev) train levitation and vehicle launchers including space launch systems.

Superconducting Transformer. The winding to application descriptions herein as applied to a transformer including the embodiment of an HTS and MTS regular to high frequency transformer. One embodiment of such a transformer may include a 3D printed core to support more advanced needs such as high frequency switching operations.

Superconducting Fault Current Limiters. The winding to application descriptions herein as applied to a superconducting fault current limiters (FCL) including the embodiment of an HTS and MTS regular to high transient and power FCL.

Superconducting Magnetic Energy Storage. The winding to application descriptions herein as applied to superconducting magnetic energy storage (SMES) including the embodiment of an HTS and MTS SMES.

Superconducting Flywheel Energy Storage. The winding to application descriptions herein as applied to a superconducting flywheel energy storage including the embodiment of an HTS and MTS regular to high speed and power flywheel.

Superconducting Flat Fan & Thin Magnets. The winding and application descriptions herein, such as “thin magnets” and/or “flat fan” magnets, apply to superconducting medium and high field magnets, including the embodiment of an HTS and MTS high field magnets for high energy physics (HEP), NMR & MRI, electric machines (motors & generators), transformers, and fusion applications greater than three Tesla (T) magnets. The thin magnet provides a very powerful, thin magnet layer, useful in a fusion tokamak or stellarator, whereas the flat fan provides an extremely powerful B magnet beyond other techniques as is required for any high field magnet device. In the case of a magnetic confinement fusion reactor, a high field is required to contain the hot plasma from the container walls. Embodiments separately focus on the benefits of either a “flat flan” or “thin magnet” based SC device. One embodiment combines the benefits of both magnet types where the “flat fan” aims the B at desired location, such as directly across an air gap, and the “thin magnet” is placed behind the “flat fan” layers to further help turn the B back to a desired location such as an air gap. The “thin magnet” uses both a self-magnet B and the HTS B exclusion to help turn the B into the desired direction. Using the flux path control and containment, via self-magnet B and HTS B flux exclusion, it is then possible to control the B for improved phasing response within a phase and across phases of an electric machine, transformer, etc. The WRAP invention allows the HTS to be formed into unique magnet profiles as required by a flat fan or thin magnet.

Superconducting Space EM Shielding. The winding to application descriptions herein as applied to superconducting electromagnetic (EM) shielding magnets including the embodiment of HTS and MTS EM shielding magnets.

SC Device Terminations. The SC or conventional conductor cryogenic magnet, cable, or cable magnet devices supporting the primary and secondary described herein may be of a hybrid construction as described in U.S. patent application Ser. No. 19/210,864, which is incorporated by reference herein. Regardless of the device type or configuration used, the device may employ the device termination assembly described in U.S. patent application Ser. No. 18/968,115, which is incorporated by reference herein. In one embodiment, both ends of an SC device comprise device terminations for electrical and (potentially) cryogen connections. Two types of SC device terminations are provided for each SC device end, with and without cryogen ports for cryogen fill and flow. The SC device terminations described are compact and expandable yet useful in dynamic environments and are, thus, configured for use in any mobile platform. The contemplated terminations also accommodate cryogen thermal contraction and expansion within the device's termination shell without adversely affecting the HTS (e.g., little or no motion or stress imparted) and do not have a cryogen gas reservoir within the SC device termination when using cryogen liquid cooling.

The SC device terminations may incorporate moving busbars constrained to only axial motion and only move with the SC device former or equivalent SC device hard connection. Only the bus moves with the thermal motion of the former because HTS tapes comprise a rigid connection between the former and the moving bus, which protects the HTS tapes from shock and dynamic influences. Epoxy with a fabric ring interweaved between tapes, or equivalent components, is incorporated over the HTS tapes and tape ends to address vibrational issues, which also provides cooling flow protection.

The SC device terminations are readily serviced with internal elements configured to be quickly replaced. That is, internal and external electrical connections are fully demountable and swappable, allowing for selective alteration of sizing and number of connectors. Both ends have funnels/donuts or equivalent shapes to assist in turning the cryogen flow and removing cryogen bubbles within the flow. Electrical separation comprised of G-10 dielectric positioned between SC device termination external/internal distribution blocks addresses the concern of electrical arcing or ice buildup that creates an electrical shorting path. Some embodiments include SC termination shell internal walls incorporating electrical dielectric coatings, allowing a compact design. Conventional conductor and/or SC flex buses allow SC device thermal expansion within the SC device termination, and provides a vibration dampening and a focus point, which reduces bolt loosening occurrences.

Termination Electrical Lug. HTS electrical terminations are typically very large and heavy to compensate for thermal contractions and expansions mentioned above. Further, avoiding HTS tape damage when bending, soldering, clamping, etc. is extremely difficult. These issues are magnified for large/long/complex devices, such as cables, with many HTS tapes requiring electrical connections. For example, one of ordinary skill in the art will appreciate that expansion and contraction effects increase in proportion to length, and bend issues increase in proportion to the size and the number of stiff tapes. Longer devices such as cables are also associated with increased electrical losses, resistive heat generation, and device sizing thermal losses. Yet, it is desirable to provide small, light, and “non-lossy” electrical terminations, especially for mobile platforms. Accordingly, some embodiments of the present invention incorporate a shaped electrical lug configured to accommodate multiple angles of the HTS tape stacks during the SC device wind off process. The shaped electrical lug also allows for all tapes to be soldered at once or groups of tapes to be individually electrically connected. One embodiment also employs a conductor compression ring that is positioned about the lug, with or without soldering.

Buffer Vessel Cryo System and Process. An SC or conventional conductor cooled with cryogen device, such as the embodiment of electric machines as described herein, may be associated with a cryogen system that employs a low-pressure buffer volume, such as a vessel, configured to absorb higher system pressures that may occur during a sudden SC quench, or other methods that turns liquid cryogen to a gas, thereby creating a high pressure that needs to be relieved. The contemplated compact and light vessel is maintained at a lower pressure than the surrounding cryogen system and is especially useful for a fully enclosed system. The vessel's primary task is to accommodate a pressure increase with associated volume expansion of liquid cryogen to gaseous cryogen that occurs during a superconductor quench, for example. The low-pressure buffer vessel, thus, increases gas reservoir volume and area to lower system pressure from a quench or another high-pressure event, thereby protecting equipment from high pressure events.

In one embodiment, passive pressure relief valves (PRV), controlled valving, etc., are used for pressure control actions. For the PRV embodiment, the buffer vessel is associated with input and output PRVs only open at desired PRV pressures maintained above the common system pressure. Multiple PRVs associated with the system may be employed via multiple lines or at least one manifold to accommodate fast pressure changes. Such a system can be designed as an open-loop or closed-loop cryogen system to support dynamic and shock environments of mobile platforms, including aircraft flight angles, and not lose any cryogen to the environment. A closed-loop cryogen system is beneficial or critical for most long-term use cases. A cryogen low pressure buffer may alleviate the need for a cryogen source on a longer SC cable run at each cryogen input location. At any time, the buffer dewar may push excess liquid cryogen or gaseous cryogen to the reservoir(s) for reliquefying. The buffer vessel can also perform the cryogen reliquification if a cryogen cold head is added.

Cryogen Liquid Level Measurement. To further enhance reliability and redundancy, some embodiments of the present invention employ a guided wave radar (GWR) system for monitoring the liquid level in the dewar cryostat mentioned above. GWR has issues working with cryogen, which has a high dielectric constant. However, one type of GWR has a coaxial hollow cylinder around a predetermined measurement area, wherein inner and outer cylinders guide the radar waves to achieve a higher fidelity signal. Most commonly, these GWR cylinder guides have holes only at the top and bottom of the cylinder. One type of coaxial cylinder is perforated with holes along the length to allow fluid access for cases where there is a fluidic separation, such as oil and water separation, to remove false readings.

As one of skill in the art will appreciate, a mobile platform, such as those that will accommodate an electric motor described herein, requires liquid cryogen levels to be assessed, wherein weight, manual, or regular electrical measurements cannot be relied upon. That is, a typical car's fuel sensor is generally comprised of an angled tube with perforated holes and an internal liquid level reading mechanism; there is no equivalent for cryo systems. Accordingly, some embodiments use the perforated outer cylinder of the GWR much like the fuel level gauge in a vehicle. The perforated outer cylinder will slow the fluid in and out of the cylinder. The contemplated GWR system will provide a fluidic average of liquid level when the liquid is moving, i.e., sloshing. Combining this type of cryogen level sensing with the option of dewar cross baffles will provide a method of lowering the fluidic motion to acquire a cryogen level in a moving vehicle.

Full Transposition of Superconductor Lead Wire Configuration. It is another aspect of some embodiments of the present invention to provide power to sensor device windings comprised of fully transposed (FT) HTS windings that support electrical and thermal conduction, thereby increasing reliability. As described in several patents and patent applications referred to herein, cable to wire transposition generally refers to rearranging conductor position in the cables or wires to minimize electromagnetic interaction. Transposition is common in power systems to enhance performance and reduce electromagnetic crosstalk. For example, in sensors to power transmission lines, transposition encompasses periodically swapping conducted positions. In cables, such as the cables, magnets, or cable magnets found in the primary and/or secondary, the conductors making up the cable are twisted about each other. Although common in conventional cables, providing a fully transposed superconducting cable with fragile superconductors and particularly with SC tapes is difficult unless careful winding techniques are used, such as those disclosed in one or more of the patents and patent applications attributed to the applicant of the instant application. This winding technique is being extended to SC lead wire configurations for power to sensor devices.

Reverse Wind Gap Bridge. Selective modification of the SC and/or conventional conductor wire or tape wind angle will provide gaps between successive winding layers that will maximize cryogen bathing of each conductor, regardless of conductor type or profile. By reversing a group wind direction between layers and providing a gap, subsequent outer tape layers will possess a “bridge” over the former between points where they rest on interior tape layers. This reverse wind gap bridge, which will be repeated with aligned gaps and bridges across tape layers, allows LN₂ to completely bathe the outer layer tapes at predetermined locations. The contemplated bridge effect is magnified for tape-to-tape separations for any tape type such as HTS and conventional conductors. Although the primary use of the reverse wind gap bridge is for liquid or gas coolant flow and/or conductive cooling access, it also helps control the location of layer-to-layer electrical connections and to improve electrodynamic canceling. The direct cooling across all HTS sides will minimize quench issues and improve quench recovery.

Mechanical Attachments. Embodiments of the present invention employ lock wire mechanical attachments, such as nuts and bolts, to address vibration shock in any SC and conventional cryogenic cable, magnet, and cable magnet device in dynamic use. For any SC and conventional high electrical power, use G-10 parts such as nuts and bolts which may also include lock wire.

Power Distribution Block. An electrical terminal distribution block is used to provide variance for the electrical connection of the common conventional conductors or SC and/or cryogen cooled conventional conductors connecting to another SC or cryogen cooled conventional device. One embodiment is made from one piece of conventional conductor, e.g., copper, which comprises a terminal rod of the distribution block that penetrates the cryogen wall, e.g. G-10 end cap, and internally connects electrically internally to electrical elements, e.g., by a two-part circumferential clamp that also attaches to flexible braided electrical conductor, commonly HTS or copper. Outside of the G-10 end cap, the terminal rod becomes a rectangular block with holes sized for wire gages of conventional power cables with an embodiment of threaded inserts with set screw for locking of non-cryogen cables.

The contemplated power distribution block can be used for any SC device for connecting non-SC electrical components to SC components. In one embodiment, the power distribution block connects at least one SC connections to at least one electrical connector constructed at least partially of conventional conductors. In operation, SC cable terminations require that cable and cable connection be planned in advance so holes on a particular termination can be predrilled. Any modification to the holes is detrimental for thermal and electrical conductivity. The contemplated power distribution block addresses this issue. Further, cryogenically cooling the power distribution block allows for better operational performance.

Metal to Non-Metal Cryostat Connection. A metal to non-metal cryostat connection for any magnet, cable, or cable magnet SC or cryogen cooled conventional conductor device is used to provide a high level of dielectric insulation. One embodiment is a cryogenic G10 cryostat connected via a flange to a vacuum jacketed stainless steel cryostat. In one embodiment, cable terminations comprise non-electrical conductors, which consist at least partially of G-10, provide an electrical break for the cryo system that protects humans, cryo pumps, sensors, etc. during high fault induced current events.

Power Boost. Power boost is used for superconductor magnet, cable, and/or cable magnet, devices and/or conventional devices including cryogenically cooled conventional conductor devices requiring extra current and/or voltage beyond their standard operational range to support needs such as system reliability and/or operational degradation, such as fault, concerns.

In one embodiment, post a quench, the allowable current in the conventional conductor surround around the SC and any adjacent conventional conductor external to the SC is much lower due to conventional conductor thermal heating limits. To accommodate a lower operational current, the system can be set to change the voltage in response to maintain an acceptable power output: (Apparent Power)=Voltage*Current. So, for an operational SC system, one embodiment will change the voltage when a power boost is required such as for a current limiting quench.

Embodiments of the present invention can be used in systems that require redundancy, e.g., an electric aircraft with performance requirements dictating the ability to travel a minimum distance, loitering, and safe landing. It is one aspect of some embodiments of the present invention to provide a device optimal for use in an electric aircraft, and other dynamic systems, where reliability is a concern. Unlike motors in a traction ground electric vehicle (EV) that require high torque (requiring electrical current) from a low starting speed and across a large speed range, an electric aircraft motor, also known in the art as a “propulsor,” often requires ranges of continuous high speeds (requiring a robust voltage range) because of the way propellers and air-breathing engines inherently operate. One embodiment of the present invention is a propulsion system capable of providing an electric vehicle power boost mode that maintains power by boosting voltage beyond normal standards, thereby lowering current in the system cables, which is especially relevant for in-flight operations where torque is not crucial. This aspect also decreases power demand, such as reducing speed and having no fast-changing high-power options and increasing the lift-to-drag ratio to support flight at lower speeds. Further, the contemplated devices can be overdesigned to accept extra current to maintain full system power with negligible cable mass or volume increase.

It is one aspect of some embodiments of the present invention to provide an electric machine, comprising: a stator carrying a plurality of armature coils each formed as a flat fan of superconducting tape having a rectangular cross section; and a rotor separated from the stator by an air gap, wherein in each armature coil the short edge of the superconducting tape faces the air gap and the long edge defines lateral side surfaces extending away from the air gap, and wherein end turns of adjacent armature coils are bent and overlapped such that the end turn regions contribute to the magnetic length of the machine.

It is still yet another aspect of the present invention to provide a method of operating a cryogenically cooled superconducting electric machine having a stator with flat fan armature coils and a rotor with selectively energizable coils, comprising: energizing the stator to start rotation with the rotor coils shorted to provide an induction response; upon reaching a predetermined speed, energizing the rotor coils to lock the machine into synchronism; and during operation, selectively modifying magnetic flux distribution by adjusting current in different tape layers and/or by activating trapped field magnets with the rotor field coils.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view of a solid core SC cable of one embodiment of the present invention showing the internal components thereof.

FIG. 2 is a perspective view of a hollow core SC cable of one embodiment of the present invention.

FIG. 3 is a perspective view of a compact superconducting motor/generator of one embodiment of the present invention.

FIG. 4 is an exploded view of FIG. 3.

FIG. 5 is an exploded perspective view of magnets that can be used in a compact superconducting motor/generator of one embodiment of the present invention.

FIG. 6 is a perspective view of a fully HTS and fully cryogenically cold electric machine (motor/generator) of one embodiment of the present invention, wherein portions have been removed.

FIG. 7 is a perspective view of a rotor employed by the electric machine shown in FIG. 6.

FIG. 8 is a perspective view a stator that employs high temperature superconducting elements in the form of flat fans employed by the electric machine shown in FIG. 6.

FIG. 8A is a cross-sectional view taken from a plane normal to a longitudinal axis of the stator shown in FIG. 8 showing a representation of a HTS winding of one embodiment and the associated air gap.

FIG. 8B is a cross-sectional view taken from the perpendicular plane shown in FIG. 8 showing three phases of one embodiment of the present invention, wherein the coils making up the phases have been flattened to enhance the description thereof.

FIG. 8C is a cross-sectional view similar to FIG. 8A.

FIG. 8D is a cross-sectional view similar to FIG. 8B, wherein a third layer of superconducting material is provided.

FIG. 8E is a general schematic showing magnetic flux behavior in a traditional electric machine.

FIG. 8F is a general schematic showing magnetic flux behavior in a flat fan as contemplated by some embodiments of the present invention.

FIG. 8G is a cross section of FIG. 8, showing a flat fan configuration of another embodiment of the present invention.

FIG. 8H is a cross section of FIG. 8, showing a flat fan configuration of another embodiment of the present invention.

FIG. 8I is a cross section of FIG. 8, showing a flat fan configuration of similar to that shown in FIG. 8A, wherein flat fans of the primary and secondary components are associated with magnet elements.

FIG. 9 is a detailed view of FIG. 8.

FIG. 10 shows a perspective view of an electric machine of another embodiment of the present invention that employs high temperature superconducting elements in the form of flat fans.

FIG. 11 shows the embodiment of an SC wound magnet around a grouping of SC bulk trapped field magnets (TFM).

FIG. 12 shows the embodiment of an SC wound magnet around and on top of a single SC bulk trapped field magnets (TFM).

FIG. 13 is a schematic of a closed loop cryogen system that includes a buffer dewar.

FIG. 14 is a front view of a cable termination assembly of one embodiment of the present invention, wherein a cable cryostat has been removed for clarity.

FIG. 15 is a perspective view of the cable termination assembly, wherein the end cap and cable cryostat have been removed.

FIG. 16 is a cross-section of the stainless steel bayonet assembly connection to an end cap.

FIG. 17 is a perspective view of an end cap.

FIG. 18A is a view of a bayonet fitting.

FIG. 18B is a view of a bayonet fitting.

FIG. 19 is a perspective view of an electrical termination distribution block.

FIG. 20 is a perspective view of an electrical lug.

FIG. 21 is a front view of a cable with the electrical lug of FIG. 20 interconnected thereto.

FIG. 22 is a schematic of a common linear motor.

FIG. 23 is schematic of another common linear motor.

FIG. 24 is a schematic of a linear motor that utilizes flat fans.

The following component list and associated numbering found in the drawings is provided to assist in the understanding of one embodiment of the present invention:

| # | Component |
|---|---|
| 2 | Cable core |
| 6 | Cladding and insulation |
| 10 | Jacket and outer wall |
| 14 | Superconducting material |
| 20 | Cable |
| 24 | HTS Layer |
| 28 | Conductive stabilizer and insulating layer |
| 32 | Cryogen path (hollow core) |
| 36 | Cryogen path |
| 504 | Magnets |
| 508 | Connecting wire/tape between magnets |
| 1100 | Motor/generator |
| 1180 | Housing |
| 1181 | Stator |
| 1182 | Rotor |
| 1183 | Non-metal shaft portion |
| 1185 | Stator coils |
| 1186 | Hollow shaft |
| 1187 | Field pole |
| 1188 | Field coil |
| 1189 | Cover with EM shield |
| 1190 | Permanent magnets |
| 1750 | Electric machine |
| 1754 | Air core |
| 1758 | Armature flat fan end turn |
| 1759 | Armature flat fan coil |
| 1760 | Magnetic coil |
| 1762 | Magnetic coil end turns |
| 1764 | Secondary flat fan coil |
| 1765 | Secondary flat fan coil end turn bend |
| 1766 | Field poles |
| 1767 | Rotor |
| 1770 | Field pole spacer |
| 1774 | Trapped field magnets |
| 1778 | Field coils |
| 1782 | Reservoir |
| 1786 | Hollow shaft |
| 1790 | Non-metal shaft portion |
| 1794 | Rotor hollow portion |
| 1800 | HTS Tape Member |
| 1802 | Superconducting material |
| 1806 | Air gap |
| 1808 | Gap |
| 1810 | Second layer |
| 1812 | First layer |
| 1814 | Third layer |
| 1818 | Thin magnet |
| 1902 | Long edges |
| 1906 | First short edge |
| 1910 | Second short edge |
| 1914 | Outer extent |
| 1918 | First short edge |
| 1920 | First magnetic coil |
| 1922 | First elongated portion |
| 1924 | Second elongated portion |
| 1926 | First end turn |
| 1928 | Second end turn |
| 1930 | First lateral side |
| 1932 | Second lateral side |
| 1934 | Third lateral side |
| 1936 | Fourth lateral side |
| 1940 | Second magnetic coil |
| 1942 | Third elongated portion |
| 1944 | Fourth elongated portion |
| 1946 | Third end turn |
| 1948 | Fourth end turn |
| 1950 | Fifth lateral side |
| 1952 | Sixth lateral side |
| 1954 | Seventh lateral side |
| 1956 | Eighth lateral side |
| 1960 | Third magnetic coil |
| 1962 | Fifth elongated portion |
| 1964 | Sixth elongated portion |
| 1966 | Fifth end turn |
| 1968 | Sixth end turn |
| 1970 | Ninth lateral side |
| 1972 | Tenth lateral side |
| 1974 | Eleventh lateral side |
| 1976 | Twelfth lateral side |
| 1902 | Long edges |
| 1906 | First short |
| 1910 | Second short edges |
| 1914 | Outer extent |
| 1918 | First short edges |
| 2100 | Cable termination assembly |
| 2104 | Cryogen port |
| 2108 | Bayonet assembly |
| 2112 | End cap |
| 2116 | Electric terminal distribution block |
| 2200 | Termination Electrical Lug |
| 2204 | SC Tape |
| 2208 | Conductor Recess |
| 3000 | Linear motor |
| 3004 | Primary component |
| 3008 | Secondary component |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

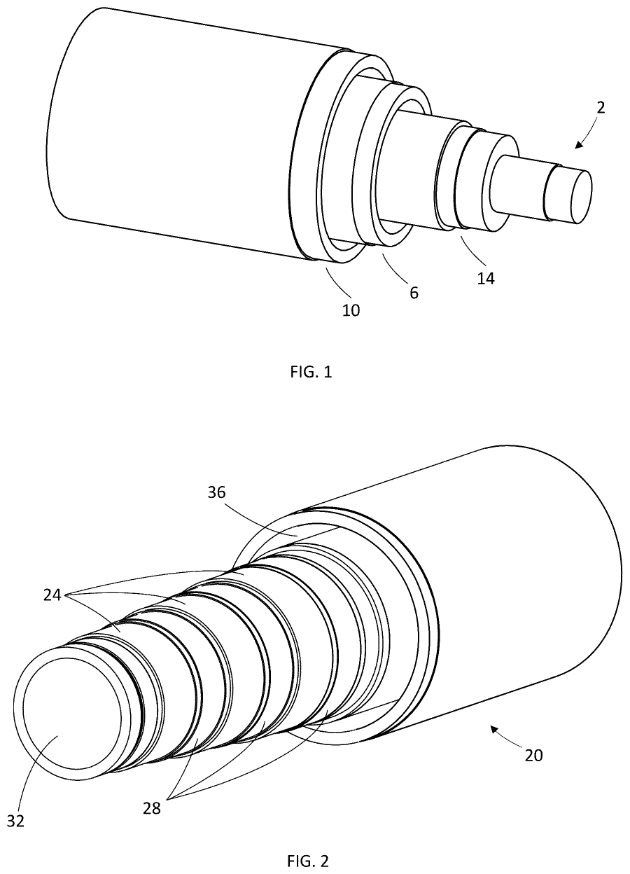

FIG. 1 shows a cable with cable core 2 where cryostat cladding and insulation 6 and jacker and outer wall of 10 are placed around the superconductor core 14. One of ordinary skill in the art will appreciate that EM shielding can be located outside the superconductor and insulation. In some embodiments, power elements are inserted into areas 6 and 14 such as the Integrated Wound Component of a spiral wrapped ultracapacitor as a nanowhisker form of energy storage system embodiment.

FIG. 2 shows further embodiments of the invention that functions as an HTS cable as also shown in FIG. 1. The device shown here is a Field Operable Superconducting Device and can function as a primary element of a Field Operable Superconducting System. FIG. 2 shows one embodiment of a 3-phase, hollow core superconducting cable 20. The cable 20 has three HTS layers 24 separated by conductive stabilizer and/or insulating layers 28. In some embodiments, cryogen flows in areas 32 and 36. In some embodiments, power elements are inserted into area 36 such as the Integrated Wound Component of a spiral wrapped ultracapacitor as a nanowhisker form of energy storage system embodiment.

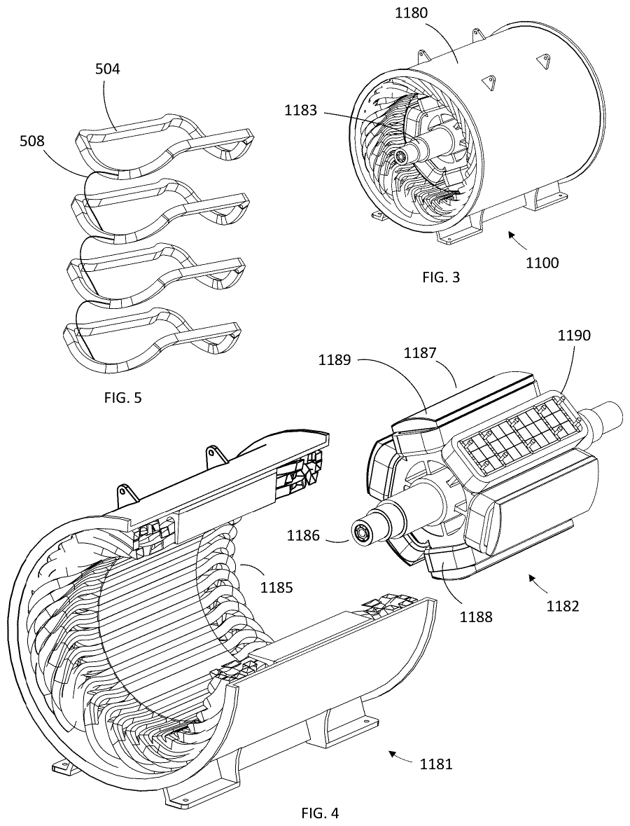

FIGS. 3-5 show a compact superconducting motor/generator 1100. The motor generator may be used in field-operable SC personal, portable devices. The machine may be half or fully HTS and, hence, half or fully cryogen cold of an electric machine (motor/generator) of any armature winding. Cryogenic cooling may be achieved by conductive cooling or a partial bath cooling, where any stator cryostat is currently not shown. For simplicity of drawings, many cryogenic, armature core, etc. elements are removed or simplified. The motor/generator 1100 comprises a housing 1180 that supports a stator coils 1185, which may be of the construction of an armature coil group shown in FIG. 5 to limit splices. That is, FIG. 5 shows a plurality of magnets 504 wound together without a continuous connection of wire or tape 508 to remove or limit the number of splices. A rotor 1182 is positioned within the stator 1185. The rotor is comprised of the shaft 1186 that supports a plurality of field poles 1187.

Trapped field magnets (TFM) 1774 or permanent magnets 1190 are placed in the field poles 1767 or 1187 in groups and surrounded by the field coils 1778 or 1188. Magnetic field focusing cover 1189 provides a transient electromagnetic (EM) shield option for all field TFMs and coils. The entire field pole 1187, even if fully HTS, can be built separately and assembled as a unit into the electric machine including the option for superconducting TFM activation outside of the machine. This case of a totally cold, cryogenic, motor or generator is possible through a non-thermal conducting hollow shaft 1186, which may have a non-metal section such as the rotor bearing optional location 1183, with a rotating cryogenic coupling with embedded slip ring-based power and data cables.

A motor and/or generator type machine embodiment includes units such as any motor and/or generator use. A motor and/or generator embodiment which is personnel portable if compact enough is shown in FIGS. 3-5 where certain cryostat elements are removed to show SC coils 1185. Motor and generator embodiments range across all types of rotary and linear AC, such as synchronous and induction machines, as well as DC machines for both a hybrid to complete SC armature and/or a hybrid to complete SC active and/or passive exciter secondary or field coils where the magnetic poles range from one or a combination of individual component, wound, TFM, PM, solid pole, etc. Embodiments also include back iron or in particular a hybrid core and/or air core motor where removal of back iron allows a lighter machine and lowered frequency losses given the SC magnetics allowing a compact machine. The superconducting machine air gap includes an evacuated or non-air air gap to remove icing of water from the air but also removes all windage loss. The air gap is the non-magnetic space between the primary and secondary of any electromagnetic device. Motor and generator machine embodiments are across an extensive number of industries and applications which are too exhaustive to readily list. One embodiment is a wind or hydro turbine generator. Another embodiment is a hybrid or all electric air, land, sea, or space vehicle motor and generator including the embodiment of a partial to complete SC type motor or generator. The embodiment of hybrid to all electric aircraft of all types and sizes are expected to make great use of this invention by itself and in particular embodiments involving the Combined Superconducting Magnetics and Speed invention disclosure and potentially the Hybrid Superconducting Magnetics invention disclosure.

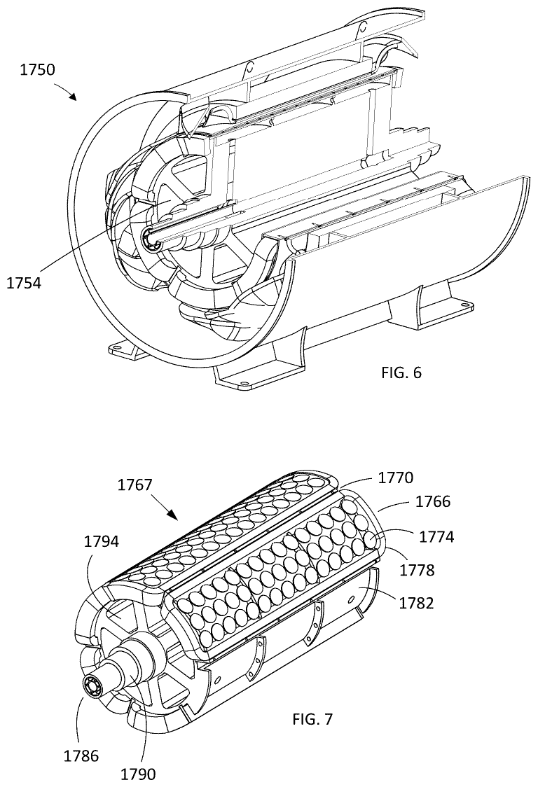

FIGS. 6-8A and 10 show an electric machine of another embodiment having hybrid or fully air core formers, and other magnetic elements placement, location, support, and operational assistance such as common to flat fan invention disclosure magnet coils, trapped field magnet (TFM) and permanent magnets, magnetic flux paths, cryostats and cryogenic cooling and conductive paths, gas paths (e.g., cryogenic liquid to gas expansion paths), electromagnetic (EM) shields and shield mounts. The electric machine 1750 is a compact advanced superconducting device that can function as a field operable superconducting device and can function as a primary element of a field operable superconducting system. The high magnetic flux density (B) provided by the machine 1750 allows a combined induction and synchronous machine. The contemplated machine is also a hybrid to air core electric machine where tape curvature and alignment for B path is provided in all armature and field coils. Here, the air core 1754 is provided on the rotor core back area, but for any air core section non-magnetic material is used to be considered air core with respect to the magnetic flux density.

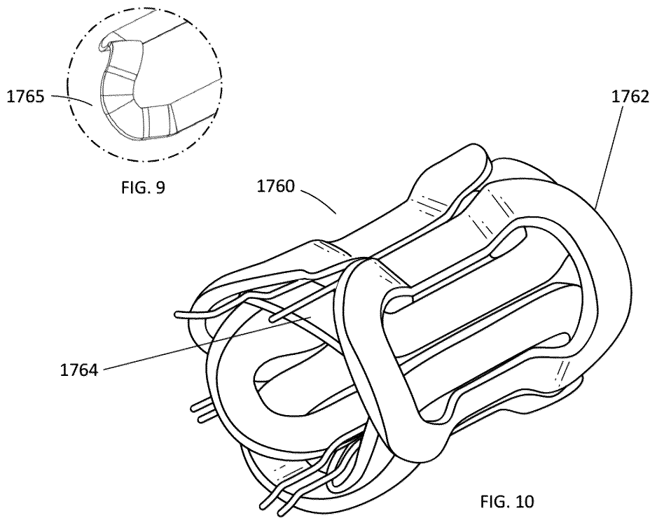

The armature coils 1759 are comprised of a flat fan magnetic coil with end turns 1758, where in this embodiment the armature is associated with the stator. Secondary coils, such as the embodiment of field coils or wound induction, may be formed as an overlapping flat fan magnetic coil such as the secondary coils 1760. FIG. 10 shows a magnetic coil 1764 where the rotor coils 1760 with a rotor diameter 1764 larger than that of the stator thus placing the armature on the inside of the rotor. Of course, the magnetic coil may be inverted where the field coils are located on a smaller diameter rotor positioned within a larger diameter stator, a more common electric machine configuration as shown in FIGS. 3 and 6. The inversion of the primary on the outside radius and secondary on the inside radius, or vice versa, to make an electromagnetic device such as an electric machine, similarly for swapping sides of an arc or linear device, will occur to those skilled in the art. As shown in FIG. 9, the flat fan end includes a turn 1765 on the primary and (FIG. 10 shows turns 1762 on the secondary) that can be set to add to the electric machine magnetic length, 1759 and 1764, respectively. This configuration also curves the B path and minimizes placement of HTS in the highest B regions. Complex, 3D-shaped SC magnets allow compact and lighter sizing for high efficiency and B without exceeding HTS critical values. Further, as seen in FIG. 6, the end turns are oriented such that poles can overlap end turns on one or both sides making them part of the magnetic length and, hence, part of the prime mover of the electric machine.

In this embodiment the curved flat fan coils and TFMs are both used to comprise the field poles 1766 on the rotor 1767. More specifically, the contemplated field coils may be common coils or flat fan with multi-dimensional curved sides to control the B path and further accommodate trapped field magnets (TFM), such as but not limited to HTS TFMs, to further increase the air gap B and output performance. The TFMs can be activated into different pole orientations. Specialized HTS EM shields 1189 are provided over the field poles 1766 with field pole spacers 1770, between armature phases, and over non-magnetic length end turns. In this hybrid superconducting magnetic configuration, the Trapped Field Magnets (TFM) 1774 or permanent magnets are placed in the field coils in groups with surrounding field coils 1778. The entire field pole 1766, even if fully HTS, can be built separately and assembled as a unit into the electric machine including the option for superconducting TFM activation outside of the machine. In one embodiment the field pole 1766 has a cryogen reservoir 1782 below conductive cooling regions to support cryo-cooling needs. Here, a totally cold, cryogenic, motor or generator is possible through the non-thermal conducting hollow shaft 1786, which may include a non-metal section 1790, with a rotating cryogenic coupling with embedded slip ring-based power and data cable connection. An evacuated or non-air (e.g., a non-water-based gas replacement such as a noble gas, nitrogen, cryogen cooling system gas, etc.) air gap, which could include evacuating other machine areas such as the back areas 1794, embodiment supports a fully cold electric machine by removing icing concerns while also removing windage.

FIGS. 6-8A and 10 show the application of winding sections where separately built winding sections are 3D printed, or otherwise created, separately wound, and then assembled and connected to form each magnet or each phase group of an armature core 1759. 3D printing, flat fan windings, TFM activation needs as a separate pole outside the device as well as when activating inside the device, and hybrid to air core machines separately and together make great use of this ability, such as the removal of magnetic material continuity needs.

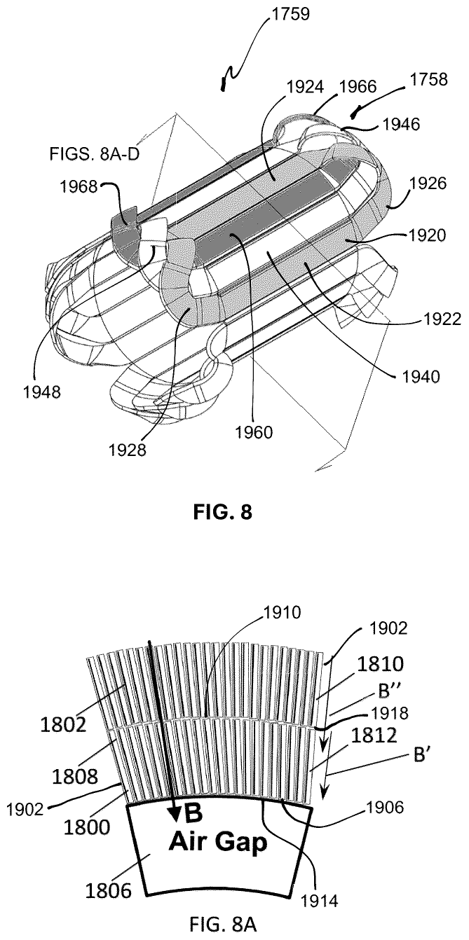

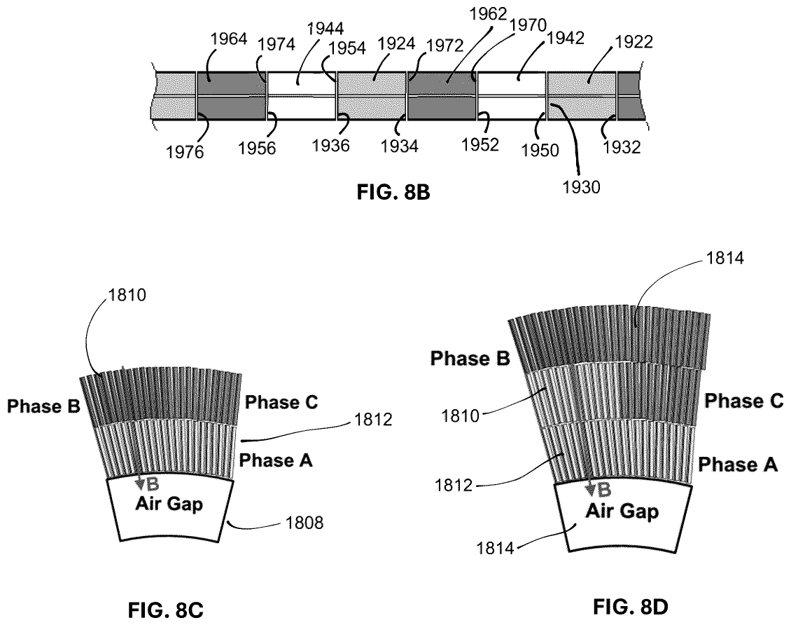

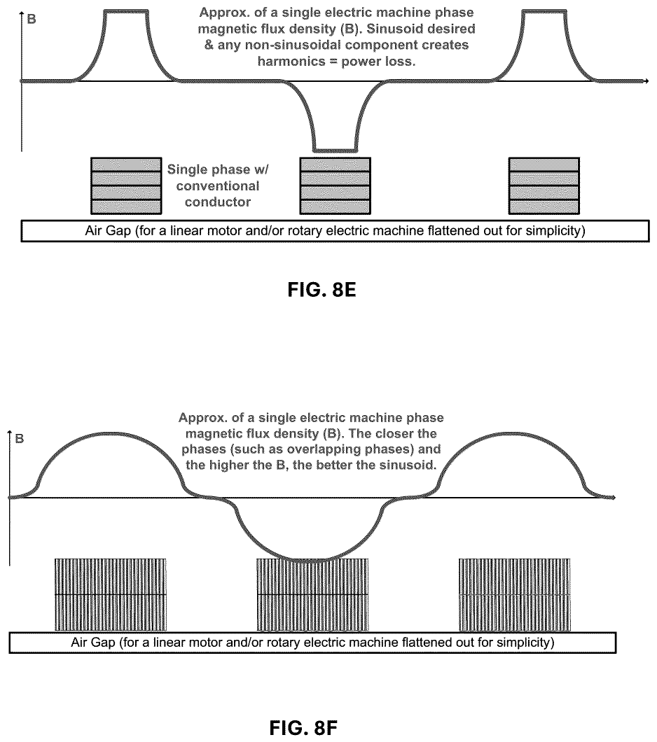

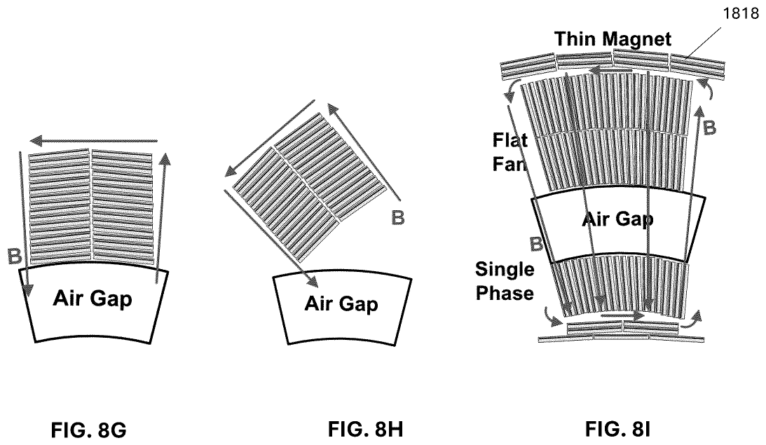

The contemplated flat fan coils, 1760 in FIG. 10 for a secondary embodiment and 1759 in FIG. 8 for an armature embodiment, uses a thin tape profile such as an HTS (often, 0.1 mm with 1 micrometer for HTS) by placing the HTS tape width (often, 2 to 12 mm) facing width along the straight length, like a shallow saddle coil that is densely packed and curved. B acts in a direction across the surface current, which is highest parallel to the longest length, so orienting the tape width perpendicular or close to perpendicular to the air gap gives an extremely distributed winding with the highest B across the air gap and the lowest losses. Long wind depths are no longer required versus a single (pancake), double, or, as expected, at most only a few layers winding. This is different than a common radial flux machine (i.e., the most common electric machine) where the B generation source is further into the slot of a machine and hence away from the air gap which then increases losses such as stray loss.

Embodiments of the present invention such as an induction SC electric machine employ wound secondary SC coils and/or squirrel cage configuration to obtain an high induced B and/or use HTS, such as many turns stacked or similarly in parallel, which provide an induced current path for starting torques and/or oscillation damping. Some embodiments remove damping by embedding Cu or aluminum (Al) amortisseur bars, variable external resistors, and/or the power electronics drive where any listed device can include cryogen cooling to increase performance. An embodiment of an electric machine primary is FIG. 8 with an inverted FIG. 10 orientation as the secondary if the secondary is short circuited.

FIG. 8A is a cross-sectional representation of a HTS winding of one embodiment of the present invention that generally illustrates the concepts of enhanced magnetic flux density (B) mentioned above. Here, a flat fan is configured in a slight “V” pattern, wherein each layer is capable of the same or different phases per layer, which will be described below. FIG. 8A shows a primary vertical configuration that provides a high power density and extremely low harmonic content.

The HTS tape member 1800 shown includes a flat strip of superconducting material 1802, which is commonly a few μm thick. The HTS winding is shown as a plurality of HTS tape members 1800 placed such that the smallest tape dimension is directed towards an air gap 1806 provided between the primary and secondary components of an electric motor, for example. The tape members could be separated by a small gap 1808 to assist desired B flow outside of the tapes. One of skill in the art will appreciate that lateral surfaces of adjacent tape members may abut.

In one embodiment, the flat fan HTS winding includes a second layer 1810 over wrapping a first layer 1812 position adjacent to the air gap 1806. The first layer 1812 and second layer 1810 produce magnetic flux B′ and B″. As magnetic flux B″ from the second layer 1810 cannot pass through the HTS within the tape of the first layer 1812 when it is superconducting, it must pass through gaps 1808 provided between HTS tape members as well as non-superconducting elements of the HTS tape member 1800. Accordingly, flux B″ from the second layer 1810 is added to the flux B′ from the first layer 1812 to define the aggregate flux B provided by the flat fan winding, which maximizes flux within the air gap 1806. Although two winding layers are shown, one of ordinary skill in the art will appreciate that additional layers may be added to increase the aggregate flux B or a single layer could also be used. Accordingly, the flat fan winding configuration contemplated herein, allows for the production of increased flux in a reduced sized component that does not suffer the drawbacks of conventional windings, e.g., flux crosstalk, magnetic field irregularities, highly separated slot or otherwise windings and all associated issues, etc. In one embodiment, current being directed to the first and second layers are controllable such that the magnetic flux provided by each layer and groups of tapes can be selectively modified.

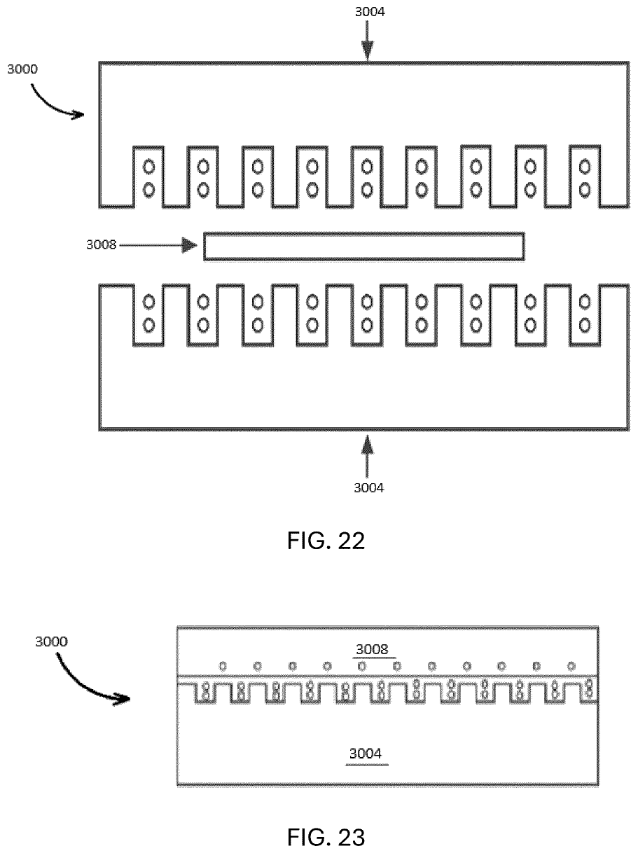

One embodiment of the present invention is an electric machine, comprising a primary component 1758 comprising a plurality of magnetic coils in the form of flat fans, and a secondary component 1764 having at least one flat fan coil, the secondary component is positioned adjacent to the primary component 1758 and separated therefrom by a gap 1806. The primary component is shown positioned within the secondary component in FIG. 10. The primary component can alternatively be placed adjacent to the secondary component in a “linear” fashion as shown in FIGS. 22-24, which will be described in detail below. The primary component configured to create an electromagnetic force that interacts with the secondary component to move the secondary component.

With particular reference to FIGS. 8, 8A, and 8B, and as discussed above, the plurality of magnetic coils of the primary component and/or the secondary component comprise a first layer of superconducting tape 1812 having a rectangular cross section defined by long edges 1902 and corresponding first and second short edges, wherein first short edges 1906 are located near an outer extent 1914 of the gap 1806, wherein the long edges 1902 extend away from the outer extent of the gap 1806 with second short edges 1910 spaced from the gap 1806, and wherein lateral side surfaces of the superconducting tape, which are defined by the long edges 1902, are spaced from each other. A second layer 1810 of superconducting tape is also provided that has a rectangular cross section defined by long edges 1902 and corresponding first and second short edges, wherein first short edges 1918 are located near the second short edges 1910 of the first layer of superconducting tape. As in the first layer, the lateral side surfaces of the superconducting tape are spaced from each other. In operation, the first layer of superconducting tape 1812 produces a first magnetic flux B′ and the second layer of superconducting tape 1810 produces a second magnetic flux B″ that passes through spaces between the lateral side surfaces of the first layer of superconducting tape 1812 and/or lateral side surfaces of the second layer of superconducting tape 1810, wherein the second magnetic flux B″ is superimposed upon the first magnetic flux B′ to define an aggregate flux B.

Thes magnetic coils of this embodiment generally comprise first, second, and third magnetic coils. The first magnetic coil 1920 comprises a first elongated portion 1922 and a second elongated portion 1924 that generally comprise the coils magnetic length, first ends of which are interconnected by a first end turn 1926, and second ends of which are interconnected by a second end turn 1928, the first elongated portion 1922 is further defined by a first lateral side 1930 and a second lateral side 1932, and the second elongated portion is further defined by a third lateral side 1934 and a fourth lateral side 1936.

The second magnetic coil 1940 comprises a third elongated portion 1942 and a fourth elongated portion 1944, first ends of which are interconnected by a third end turn 1946, and second ends of which are interconnected by a fourth end turn 1948, the third elongated portion 1942 is further defined by a fifth lateral side 1950 and a sixth lateral side 1952, and the fourth elongated portion 1944 is further defined by a seventh lateral side 1954 and an eighth lateral side 1956.

The third magnetic coil 1960 comprise a fifth elongated portion 1962 and a sixth elongated portion 1964, first ends of which are interconnected by a fifth end turn 1966, and second ends of which are interconnected by a sixth end turn 1968, the fifth elongated portion 1966 is further defined by a ninth lateral side 1970 and a tenth lateral side 1972, and the sixth elongated portion 1964 is further defined by an eleventh lateral side 1974 and a twelfth lateral side 1976

In one embodiment, the primary component and/or the second component are substantially “slotless,” wherein the second lateral side 1930 engages the fifth lateral side 1950, the sixth lateral side 1952 engages the ninth lateral side 1970, the tenth lateral side 1972 engages the third lateral side 1934, the fourth lateral side 1936 engages the seventh lateral side 1954, and the eighth lateral side 1956 engages the eleventh lateral side 1974, to define slotless to minimal slot engagements between the first magnetic coil 1920, the second magnetic coil 1940, and the third magnetic coil 1960. In addition, the first end turn 1926, second end turn 1928, third end turn 1946, fourth end turn 1948, fifth end turn 1966, and sixth end turn 1968 have bends configured to allow portions of the first end turn and third end turn, portions of the third end turn and fifth end turn, portions of the second end turn and fourth end turn, and portions of the fourth end turn and sixth end turn to selectively interconnect. The contemplated end turns increase an effective magnetic length of the first elongated portion, the second elongated portion, the third elongated portion, the fourth elongated portion, the fifth elongated portion, and/or the sixth elongated portion.

Instead of dedicating each coil to its own phase, the embodiments shown in FIGS. 8C and 8D show how the layers of a flat fan assembly can be configured to define multiple phases. In FIG. 8C, the first layer of superconducting material defines first phase (Phase A) and the second layer of superconducting material defines second and third phases (Phase B and Phase C). Likewise, in FIG. 8D, Phase A is split more and portions thereof are found in the first layer and second layer of superconducting material. Here, a third layer superconducting material is provided that accommodates a part of Phase B and Phase C, wherein the other portion thereof is accommodated by the second layer of superconducting material.

FIGS. 8E and 8F show the contrast between traditional electric motors and electric motors that employ flat fan concepts. One of ordinary skill in the art will appreciate that a magnetic flux density having as close to a sinusoidal profile is desired as any non-sinusoidal aspect of the magnet flux will create harmonics, which equates to power loss. FIG. 8F generally illustrates how the flat fan configuration shown, for example, in FIG. 8A allows the phases to direct magnetic flux in such a way to create a substantially sinusoidal flux density.

FIGS. 8G and 8H illustrate how superconducting elements that comprise the flat fan layers can alternatively be arranged. FIG. 8G shows a horizontal configuration wherein the lateral sides of superconducting tape are generally aligned with the outer extent of the air gap. This configuration allows for a large, localized B when desired, which is enhanced by HTS B exclusion. FIG. 8H shows how the larger, lateral sides of the superconducting tape to be angled with respect to the radial vector of the air gap's outer extent to allow for a large, focused B when desired.

FIG. 8I, which shows a configuration similar to that shown in FIG. 8A, illustrates how magnetic flux is directed through the air gap and then reversed with the aid of thin magnets 1818.

One embodiment of the present invention is a combined induction and synchronous SC electric machine. The machine is similar to the induction SC electric machines described above with secondary SC coils to form an induced passive B (inductive) or active B (synchronous) type electric machine where configurations such as switching vary machine types operationally. The secondary SC coils may be shorted for an induction machine response and coils are active with or without TFMs or permanent magnets (PM) for a synchronous machine response. Oscillation damping can be controlled with embodiments such as a high B locking rotor, introduced inductance effects, external resistance with optional cryo cooling effects. Another embodiment includes variable pole options for how rotor based electrical switches close as passive inductive or active field coils.

A further embodiment that is not a compact system in the strict sense of personnel portable but is compact regarding how all elements must be as light as possible is exemplified in a spacecraft EM shield. In this case a set of large SC coils are arranged around a spacecraft providing a B shield to protect the spaceship and occupants from harmful EM radiation and ions. Although the coils are very large, they assume many of the properties of compact coils such as the need to increase specific power and power density to allow a launch into and then use in space as well as long term robustness without failure. Hence all appropriate embodiments apply to this larger system.

One embodiment allows a large B in the air gap that in turn allows a higher power system including a higher speed and torque propulsion system as well as a higher energy levitation system for the combined use of maglev and magprop. One embodiment is an SC based linear motor for vehicle launch purposes such as aeronautical and aerospace (see, FIGS. 22 and 23). Another embodiment is an advanced SC such as HTS based superconducting maglev and/or magprop including commercial train speeds to high-speed vehicles beyond commercial train limits including Mach 1 or greater test sleds.

Embodiments of these hybrid magnetics include conventional magnetics to a hybrid motor and generator. In the motor and generator embodiments, SC to complete SC armature, exciter field coil, and AC induction machine passive conductor. Such embodiments of various magnetics options, in particular combining SC wound and TFM, allow not only a proper magnetic solution for a given task but in particular allow for a very compact machine.

In a motor and/or generator embodiment any magnetic type including SC combination units are held down via epoxy and/or mechanical bolts and/or dovetails and/or banding/retaining rings which increases stray losses through a larger air gap and then a different banding option is often employed such as for high-speed machines.

Historically SC bulk and wire materials are used separately across applications. The combined benefits of both are not utilized in a single unit to date.

In one embodiment a system for combining SC wire and trapped field bulk material is presented. This combination provides the ability to capture the greatest benefits of both SC formats at a common cryogenic state. Benefits include magnetic field forming to bulk material activation.

A key embodiment for any SC device is a wound SC such as a magnetic coil wound around a single or group of TFM magnets and used to both activate and then modify the field of a TFM. As a further embodiment these combined SC type poles can be created as separate units to include into the machine for ease of assembly as well as activation of the TFM outside of the SC device or in place in part or whole in the final SC device. This embodiment also allows line replaceable unit (LRU) solution.

This invention relates to methods of generating high magnetic fields from SC material for the purposes of TFM activation, high B augmentation control, and high B fields in a desired output form.
1. Superconducting (SC) wire coil and SC trapped field magnet (TFM) bulk materials are used in combination to supplement one another's SC magnetic field.
   a. The TFM can be positioned at the magnetic lower or higher points of an SC coil for enhancing or augmenting DC, AC, or pulsed field generated.
   b. TFMs places in the typical void between the SC coil sides and using both SC types in operation allows for a much higher B capability than using either a TFM or SC coil separately.
2. SC wire coil is used to augment the TFM magnetic field
   a. Readily change the magnetic flux density, B, on the SC wire with a varying static DC field change or even an AC to transient depending on the output B desired.
   b. Augmented field machines provide a wonderful machine control technique. Augmenting a uniquely high B is currently unheard of in practice.
3. Use SC wire coil to provide a high TFM material ACTIVATION energy.
   a. TFMs require high activation energies to acquire a high B. Such activation is extremely difficult to achieve. Difficulties arise from the ability to get a high B to the TFM due to reasons such as inductance path to magnetic stray and conductive shields when trying to activate external to the SC cryostat. By placing the SC wire inside of the same cryostat with the TFM bulk then one can make use of not only the high B capability of the SC wire coil but also the close proximity of the SC wire generated B to the TFM activated captured B.
   b. Utilizing an SC wire, unlike conventional a conventional conductor such as copper, the SC wire can handle an extreme current for a short period of time when devoid of pinning centers and typically generates orders of magnitudes less thermal energy than a pure conductor. Minimizing heat generation is extremely beneficial for any SC coil.
   c. The wire is automatically located inside of the cryostat whether around the entire SC bulk pack or next to individual TFMs. In the individual TFM case the coil may be located physically around the TFM or on top of the TFM center. In this case multiple SC coils may be connected in series and/or in parallel to achieve activation.
   d. Once the TFMs are activated, or when using an SC DC magnet without TFMs, the SC DC magnet can set for a steady state mode, such as a motor or generator exciter field or NMR or MRI field magnet, will theoretically never lose the DC steady state charge with the only SC loss occurring from any mostly negligible splice resistance.
   e. Use secondary and primary magnet windings in an appropriate orientation to achieve increased levels of TFM activation and/or deactivation energies, times, and TFM B orientations.
4. Use SC wire coil to provide a high TFM material DEACTIVATION energy.

The same coil case of this invention may be used to also deactivate the TFM bulk materials. In this case the SC coil is purposely placed into a quench situation through means such as but not limited to forcing the SC coil(s) to quench through the external power supply or as sudden opening of a potential persistent switch for reasons such as inducing a localized heating zone.

An SC wire is able to be formed in many shapes from pure solenoids to saddle coils, yet this form always has magnetic field distributions such as high B points at the coil turns due the multiple coil legs interacting strongly in that region. A TFM is a small entity that provides a magnetically flux dense field up to the TFM saturation levels in the center areas of the TFM itself where the B distribution approximates an ice cream cone shape. This combination allows one to use the B distributions inherent to both material forms to best create a desired output field from a uniform B with a possible smoothed entering and exit pole region entering a machine air gap to lower the non-fundamental harmonic content. Such affects assist machine design to a dipole or quadrupole particle accelerator magnet where a very high but uniform B is crucial. As for a machine case the placement of TFMs into the typical void between the SC coil sides and using both the SC Coil and TFMs in parallel while in operation allows for a higher output B than either the independent SC Coil or TFM. This allows a much higher power dense machine than either an SC Coil or TFM alone.

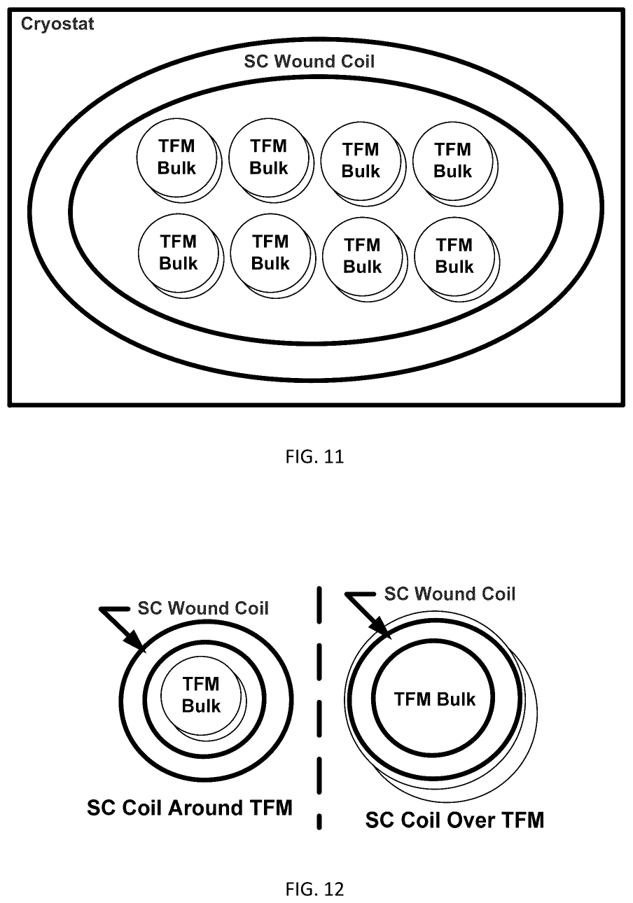

Activation and deactivation of a TFM is of extreme importance yet to date not a solved problem for a large machine. Activation techniques are complex and work on controlled B and cryogenic temperatures which may even involve controlled cryogenic pressures. To use the fact that both SC wires and SC TFM bulks must exist within an SC critical state that includes cryogenics, then one is able to readily make use of placing both SCs into the same cryostat. Using this SC coil for activation has the extreme benefit of not forcing a B pulse through a conductive cryostat wall and other supporting material as well as the SC wire generates orders of magnitudes less heat than using a typical conductor for activation. To add, by placing the TFM activation and deactivation as close to the TFM as possible, then less overall energy is required for either TFM activation or deactivation. An example of a TFM bundle with a single SC Wound Coil around the stack is provided in FIGS. 3, 4, and 11 where the removable field pole 1767, for general purposes and TFM activation, has field coil 1778 wrapping around the TFM stack 1774 and magnetic field focusing cover 1189 (not shown for TFM pole but for a PM pole here). An example of a single TFM with a dedicated and single SC Wound Coil per TFM whether around the outside of the TFM or centered on the TFM physical center is provided in FIG. 12. In this second example the dedicated TFM coils are connected in either a parallel and/or series connection to an outside power supply. In either SC coil and TFM case the SC coil and TFM materials are likely in the same cryostat but not necessarily since there are advantages to also separate the SC bulk and SC wire coils for reasons such as making use of magnetic dampers. In either SC coil and TFM case a SC persistent switch may or may not be used.

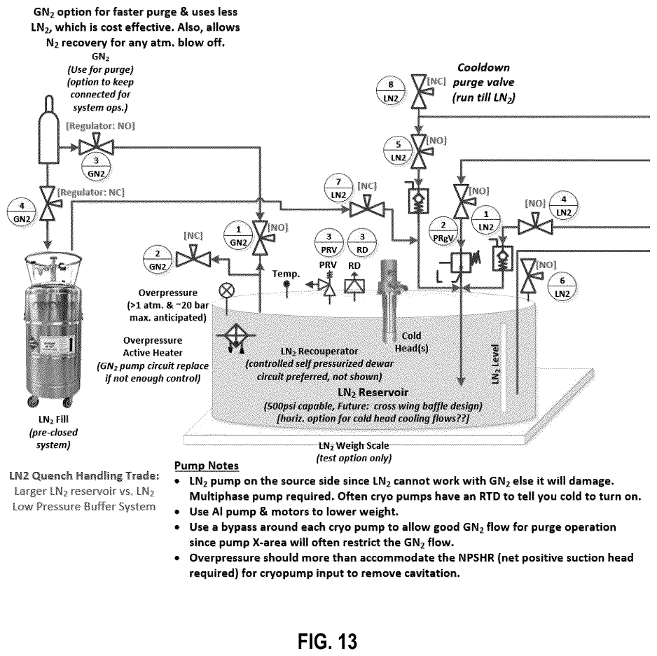

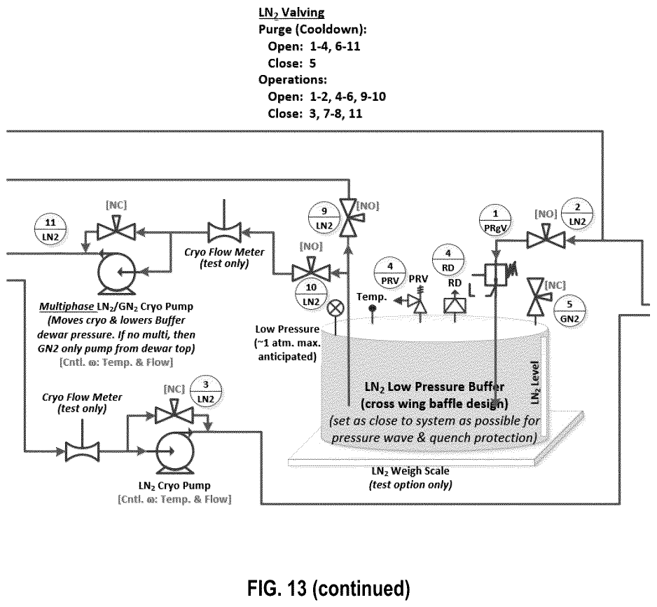

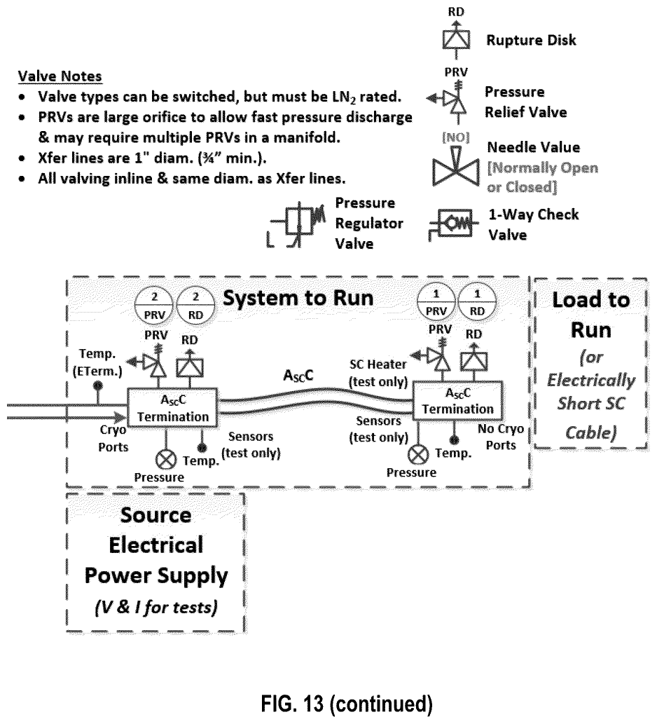

Some of the electric devices described herein require a cryogen system to maintain a predetermined temperature. FIG. 13 shows a cryogen system of one embodiment of the present invention that includes a low-pressure buffer volume, such as a vessel, configured to absorb higher system pressures. The compact and light vessel is maintained at a lower pressure than the surrounding cryogen system and is especially useful for a fully enclosed system. The vessel's primary task is to accommodate a pressure increase with associated volume expansion of liquid cryogen to gaseous cryogen that occurs during a superconductor quench, for example. The low-pressure buffer vessel, thus, increases gas reservoir volume and area to lower system pressure from a quench or another high-pressure event, thereby protecting equipment from high pressure events.

The buffer vessel, such as a dewar cryostat, is maintained at a lower pressure than the connected cryogen system. Passive pressure relief valves (PRV), controlled valving, etc., are used for pressure control actions. For the PRV embodiment, the buffer vessel is associated with input and output PRVs only open at desired PRV pressures maintained above the common system pressure. Multiple PRVs associated with the system may be employed via multiple lines or at least one manifold to accommodate fast pressure changes. Such a system can be designed as an open-loop or closed-loop cryogen system to support dynamic and shock environments of mobile platforms, including aircraft flight angles, and not lose any cryogen to the environment. A closed-loop cryogen system is beneficial or critical for most long-term use cases. A cryogen low pressure buffer may alleviate the need for a cryogen source on a longer SC cable run at each cryogen input location. At any time, the buffer dewar may push excess liquid cryogen or gaseous cryogen to the reservoir(s) for reliquefying. The buffer vessel can also perform the cryogen reliquification if a cryogen cold head is added.

Other aspects shown in FIG. 13:
1) Pump aspects:
   LN2 pump on the source side since LN₂ cannot work with GN₂ else it will damage. Multiphase pump required. Often cryo pumps have an RTD to tell you cold to turn on.
   Use Al pump & motors to lower weight.
   Use a bypass around each cryo pump to allow good GN₂ flow for purge operation since pump X-area will often restrict the GN₂ flow.
   Overpressure should more than accommodate the NPSHR (net positive suction head required) for cryopump input to remove cavitation.
2) Valve aspects:
   Valve types can be switched but must be LN₂ rated.
   PRVs are large orifice to allow fast pressure discharge and may require multiple PRVs in a manifold.
   Transfer lines are 1″ diam. (0.75″ min.).
   All valving inline and same diameter as transfer lines.
3) GN2 option for faster purge and uses less LN₂, which is cost effective. Also, allows N₂ recovery for any atm. blow off.

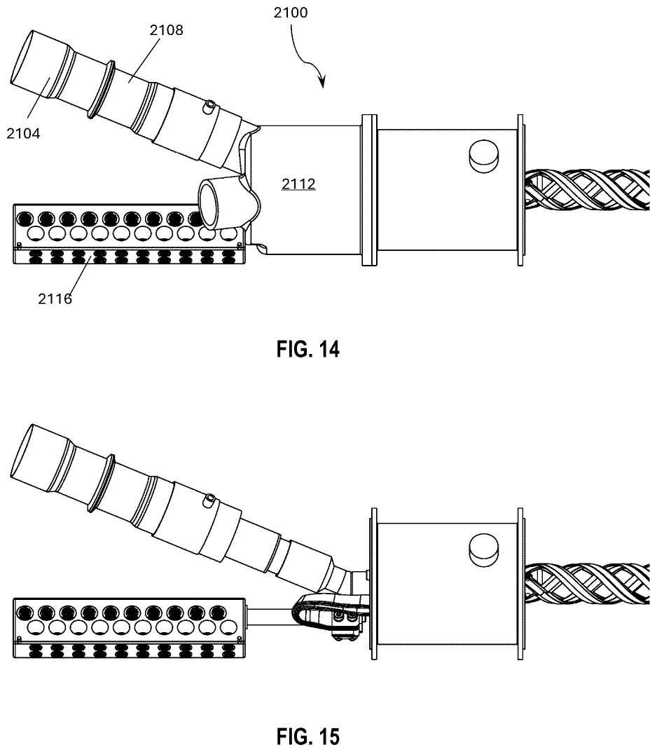

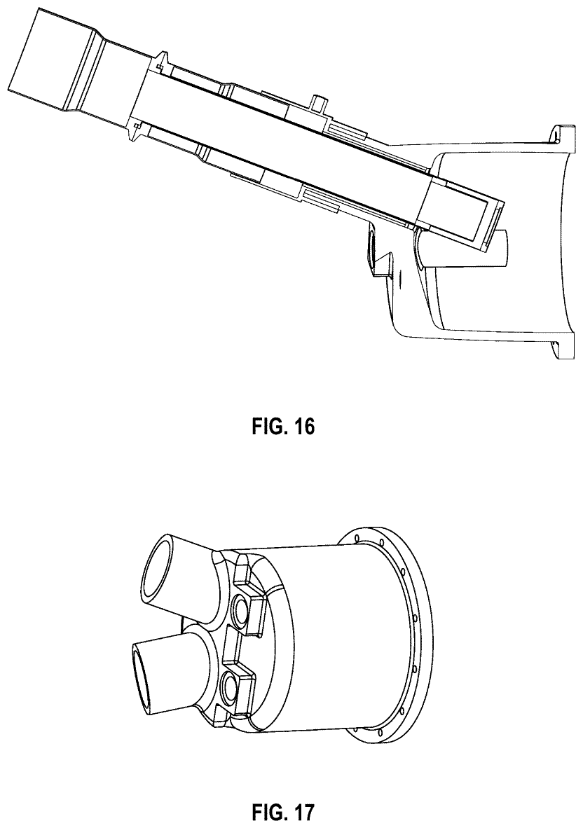

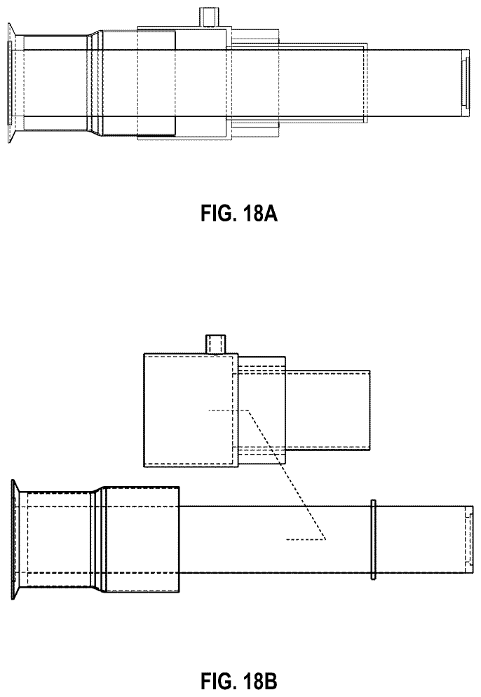

FIGS. 14-19 show a cable termination assembly 2100 used with some embodiments of the present invention. FIG. 14 shows a cryogen port 2104 with attached bayonet assembly 2108. Bayonet assembly 2108 contains female half welded to an adapter that threads to G-10 end cap 2112. The male half slides into the female half, seals with an O-ring, and attaches with a circumferential clamp (not shown). An electrical terminal distribution block 2116 made from one piece of conventional conductor, e.g., copper, comprises a terminal rod of the distribution block that penetrates the cryogen wall, e.g. G-10 end cap, and internally connects electrically internally to electrical elements, e.g., by a two-part circumferential clamp that also attaches to flexible braided electrical conductor, commonly HTS or copper as shown here, straps. Outside of the G-10 end cap, the terminal rod becomes a rectangular block with holes sized for wire gages of conventional power cables and threaded inserts at 90 degrees to these cable holes that provide for set screw locking of cables. FIG. 18 shows the cable termination with the end cap removed to expose the gasket that seals the electrical terminal distribution block and the continuing path for cryogen flowing into the bayonet assembly on its way into a SC-wrapped metal hose former shown on the right. The electrical connection to the flexible strap described above is also shown here.

FIGS. 18A and 18B show the three pieces of the bayonet assembly (female bayonet, adapter, and bayonet seal ring). The bayonet seal ring is welded to the adapter and the female bayonet, enclosing a vacuum area in this assembly.

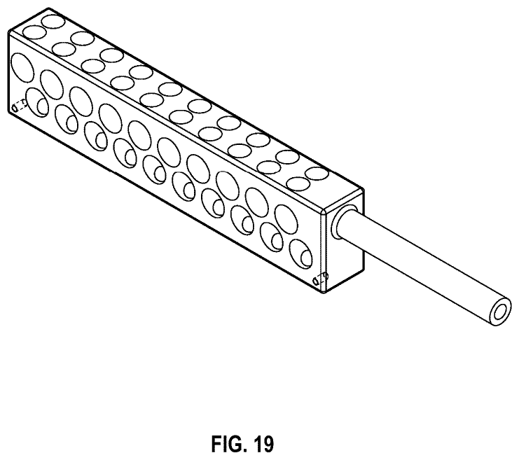

FIG. 19 shows an electrical terminal distribution block machined from one piece of conventional conductor, here copper. Threaded inserts are installed in the top and bottom holes for two places where setscrews secure each cable that is inserted into the front face.

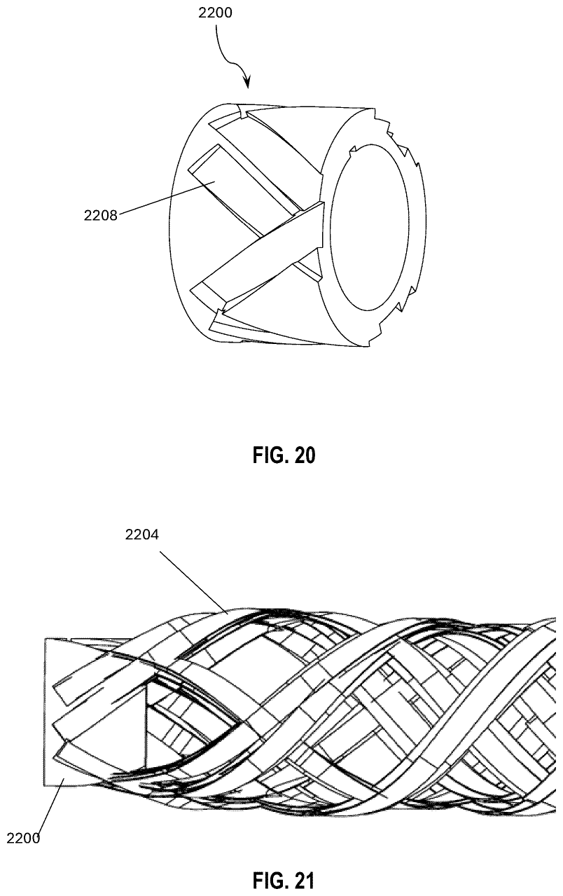

FIGS. 20 and 21 show an electrical lug 2200 used by some embodiments of the present invention. In operation, SC tape 2204 (or a plurality of tapes) is placed in a recess 2208 integrated into the lug and soldered thereto. In some embodiments, a soldering collar (not shown) is placed around the lug to prevent excess solder flow while filling the recess. Alternatively, a compression ring may be used with or without the soldering collar. The lug supports the use of moving busbars as described herein.

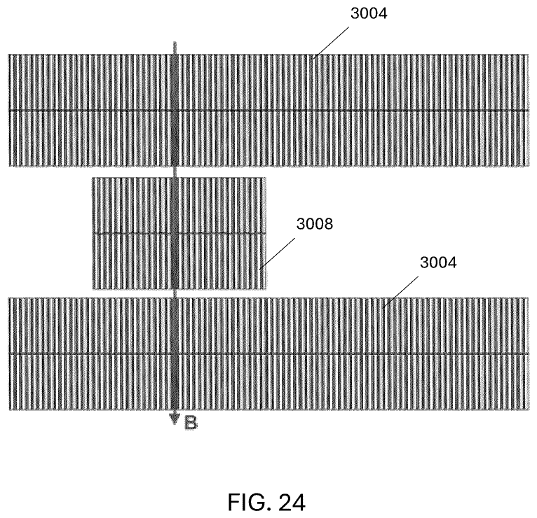

FIGS. 22-24 show linear motors 3000 of some embodiments of the present invention that are generally comprised of a primary component 3004 and a secondary component 3008. Typically, typically, the primary component is stationary and the secondary component moves with respect to the primary component. However, those of ordinary skill in the art will appreciate that the reverse can be true. FIG. 24 shows a linear motor wherein the primary component and/or secondary component are comprised of flat fans as described above.

Although the description of some embodiments of the present invention above is mainly directed at a superconductor wire, tape and cable, it should be recognized that the invention could be applicable to any linear media and in particular delicate linear media. As used herein, the term “delicate linear media” will include advanced superconducting wire and tape, very fine conventional wire, filamentary linear materials, fiber optic wire, thin strands of carbon-based fiber, smart fabrics, and extremely dense fine fiber matrices. Further, the present invention can be applied not only to coil and cable winding but also to any other delicate media handling process including but not limited to media insulating, bending, braiding, forming, splicing, heat or chemical treatment such as reacting, encapsulation, inspecting, and any manual or automated process that requires handling the media safely. As used herein, the terms “wire,” “tape,” “cable,” and “media” are used interchangeably. Some embodiments of the present invention can be applied to allow an automatic winding (or other similar) process. Also, the term “spool” is used herein to refer to any object onto which the delicate liner media is wound, regardless of the object's shape. Industry language commonly refers to a wind-off spool as “spool” and wind-on spool as “former” or “bobbin,” and those terms may also be used interchangeably herein. Whenever the terms “automatic,” “automated,” or similar terms are used herein, those terms will be understood to include manual initiation of the automatic or automated process or step.

The invention has broad applicability and can provide many benefits as described and shown in the examples above. The embodiments will vary greatly depending upon the specific application, and not every embodiment will provide all the benefits and meet all of the objectives that are achievable by the invention. In the previous discussion and in the claims, the terms “including” and “comprising” are used in an open-ended fashion, and thus should be interpreted to mean “including, but not limited to . . . .” To the extent that any term is not specially defined in this specification, the intent is that the term is to be given its plain and ordinary meaning. The accompanying drawings are intended to aid in understanding the present invention and, unless otherwise indicated, are not drawn to scale.

While various embodiments of the present invention have been described in detail, it is apparent that modifications and alterations of those embodiments will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that it would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. An electric machine, comprising:
a stator carrying a plurality of armature coils each formed as a flat fan of superconducting tape having a rectangular cross section; and
a rotor separated from the stator by an air gap,
wherein in each armature coil the short edge of the superconducting tape faces the air gap and the long edge defines lateral side surfaces extending away from the air gap, and wherein end turns of adjacent armature coils are bent and overlapped such that the end turn regions contribute to the magnetic length of the machine.

2. The machine of claim 1, wherein the stator is slotless or shallow slot and the machine is air core at the armature region.

3. The machine of claim 1, wherein the air gap is evacuated or filled with a non air gas, thereby reducing windage and icing while supporting cryogenic operation.

4. The machine of claim 1, wherein each flat fan armature coil comprises a first layer of superconducting tape adjacent the air gap and a second layer radially outside the first layer, the first layer comprising plural parallel tape segments separated by inter tape gaps, and wherein magnetic flux generated by the second layer passes through the inter tape gaps of the first layer to add to magnetic flux in the air gap.

5. The machine of claim 4, wherein the end turns are bent at 45° or less relative to the straight armature length so that the end turns overlap a pole region and form part of the useable magnetic length.

6. The machine of claim 1, further comprising electromagnetic shields between adjacent armature phases and over armature end turns, the shields comprising shorted HTS strips or cryogenically cooled conductive metal.

7. The machine of claim 1, wherein an outer extent of the flat fan is associated with thin magnets.

8. The machine of claim 1, wherein the rotor comprises field poles including trapped field magnets (TFMs) and/or field coils, the field coils being configured to activate the TFMs and to augment or shape the pole flux during operation.

9. The machine of claim 1, wherein the rotor and stator are cryogen cooled.

10. The machine of claim 1, wherein the rotor further includes a non metal thermal break section and a rotating cryogenic coupling that accommodates power and data.

11. The machine of claim 1, further comprising a rotary exciter/transformer configured to deliver power across a rotating interface to superconducting or cryogenically cooled coils.

12. The machine of claim 1, configured to operate selectively in an induction mode or a synchronous mode, wherein rotor coils are shorted for induction and energized for synchronous operation, and wherein coil connections are selectable to change pole count.

13. The machine of claim 12, wherein transition control between induction and synchronous modes is configured to lock the rotor from slip into synchronism while limiting oscillations, with damping provided by the damping bars and/or external resistors.

14. The machine of claim 1, wherein the superconducting tape is thermoplastically insulated and the armature and/or field coils further include a reverse wind gap bridge pattern that enhances cryogen access to tape surfaces.

15. A stator subassembly for a superconducting electric machine, comprising:
a cylindrical support structure; and
a circumferential array of flat fan armature coils disposed on the support structure, each coil formed of parallel, side by side segments of superconducting tape having a rectangular cross section with the short edge facing an air gap, wherein adjacent coil end turns are overlapped and oriented to contribute to the machine's magnetic length.

16. The stator subassembly of claim 15, wherein each flat fan armature coil includes a first tape layer adjacent the air gap and a second tape layer radially outside the first, and wherein the first layer comprises gaps between adjacent tapes through which magnetic flux from the second layer is directed into the air gap.

17. The stator subassembly of claim 15, wherein the lateral side surfaces of the tape in at least one layer are not normal to the curvature of the air gap, thereby reducing perpendicular flux components across the tape width.

18. The stator subassembly of claim 15, wherein the end turns are bent at 45° or less relative to the straight portions and are overlapped by a pole region on at least one side of the stator.

19. The stator subassembly of claim 15, wherein the coil turn pattern is a V pattern with partial overlap between adjacent turns to reduce harmonic content.

20. The stator subassembly of claim 15, further comprising EM shields between phases and over end turns formed by shorted HTS strips and/or cryo cooled metal foils disposed proximate to the flat fan coils.

21. A method of operating a cryogenically cooled superconducting electric machine having a stator with flat fan armature coils and a rotor with selectively energizable coils, comprising:
energizing the stator to start rotation with the rotor coils shorted to provide an induction response;
upon reaching a predetermined speed, energizing the rotor coils to lock the machine into synchronism; and
during operation, selectively modifying magnetic flux distribution by adjusting current in different tape layers and/or by activating trapped field magnets with the rotor field coils.

22. The method of claim 21, further comprising applying external resistance to the rotor circuit during start to limit inrush current and then decreasing the resistance as the machine accelerates.

23. The method of claim 21, further comprising operating the machine with an evacuated or non air air gap and EM shields between phases and over end turns to reduce harmonic and transient losses.

24. The method of claim 21, wherein the stator coils include a first tape layer and a second tape layer separated by inter tape gaps in the first layer, and the method includes controlling the currents so that flux from the second layer is driven through the gaps to add to flux from the first layer in the air gap.

25. The method of claim 21, further comprising powering one or more superconducting coils across a rotating interface using a rotary exciter/transformer.
